(19) United States
(12) Patent Application Publication
(10) Pub. No.: US 2025/0175907 A1
(43) Pub. Date: May 29, 2025

(54) METHOD FOR TRANSMITTING SOUNDING REFERENCE SIGNAL FOR DOWNLINK CHANNEL STATE ACQUISITION IN WIRELESS COMMUNICATION SYSTEM

(71) Applicant: SAMSUNG ELECTRONICS CO., LTD., Suwon-si (KR)

(72) Inventors: Seongmok LIM, Suwon-si (KR); Youngrok JANG, Suwon-si (KR); Hyoungju JI, Suwon-si (KR)

(21) Appl. No.: 18/955,671

(22) Filed: Nov. 21, 2024

(30) Foreign Application Priority Data
Nov. 23, 2023 (KR) 10-2023-0164393
Aug. 27, 2024 (KR) 10-2024-0115234

(51) Int. Cl. H04W 52/24; H04L 5/00

(52) U.S. Cl. CPC H04W 52/242; H04L 5/0048

(57) ABSTRACT

The disclosure relates to a 5G or 6G communication system for supporting higher data rates. The disclosure provides a method performed by a terminal in a wireless communication system. The method comprises: receiving, from a base station, configuration information related to a usage and a type of one or more sounding reference signal (SRS) resource sets; receiving, from the base station, information on a transmission configuration indication (TCI) state for the one or more SRS resource sets; and determining, based on the configuration information and the TCI state, a transmission power of the one or more SRS resource sets.

### CROSS-REFERENCE TO RELATED APPLICATIONS

This application is based on and claims priority under 35 U.S.C. § 119 to Korean Patent Application No. 10-2023-0164393 filed on Nov. 23, 2023, and Korean Patent Application No. 10-2024-0115234 filed on Aug. 27, 2024, in the Korean Intellectual Property Office, the disclosures of which are herein incorporated by reference in their entirety.

### BACKGROUND

### 1. Field

The disclosure relates to the operations of a user equipment (UE) and a base station in a wireless communication system. Specifically, the disclosure relates to a method in which a base station schedules a sounding reference signal (SRS) and a UE transmits the scheduled SRS in a wireless communication system, and an apparatus for performing the method.

### 2. Description of Related Art

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Embodiments disclosed herein are to provide a device and a method capable of effectively providing services in a wireless communication system.

A method performed by a terminal in the present disclosure to solve the above problems includes receiving, from a base station, configuration information related to a usage and type of one or more sounding reference signal (SRS) resource set; receiving, from the base station, information on a transmission configuration indication (TCI) state for the one or more SRS resource set; and determining, based on the configuration information and the TCI state, a transmission power of the one or more SRS resource set.

A method performed by a base station in the present disclosure to solve the above problems includes transmitting, to a terminal, configuration information related to a usage and type of one or more sounding reference signal (SRS) resource set; transmitting, to the terminal, information on a transmission configuration indication (TCI) state for the one or more SRS resource set; and wherein a transmission power of the one or more SRS resource set is determined.

Embodiments disclosed herein provide a device and a method capable of effectively providing services in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a basic structure of a time-frequency domain in a wireless communication system according to an embodiment of the present disclosure;

FIG. 2 illustrates an example of a structure of a frame, a subframe, and a slot in a wireless communication system according to an embodiment of the present disclosure;

FIG. 3 illustrates an example of a bandwidth part configuration in a wireless communication system according to an embodiment of the present disclosure;

FIG. 4 illustrates an example of a beam application time that may be considered when using a unified TCI scheme in a wireless communication system according to an embodiment of the present disclosure;

FIG. 5 illustrates another example of a MAC-CE structure for activation and indication of a joint TCI state or separate DL or UL TCI state in a wireless communication system according to an embodiment of the present disclosure;

FIG. 6 illustrates an example of a control resource set configuration of a downlink control channel in a wireless communication system according to an embodiment of the present disclosure;

FIG. 7 illustrates an example of a structure of a downlink control channel in a wireless communication system according to an embodiment of the present disclosure;

FIG. 8 illustrates an example of an SRS antenna switching operation according to an embodiment of the present disclosure;

FIG. 9 illustrates an example of SRS carrier switching according to an embodiment of the present disclosure;

FIG. 10 illustrates an example of transmitting an SRS resource within an SRS resource set with RRC parameters configured based on a unified TCI framework extension according to an embodiment of the present disclosure;

FIG. 11 illustrates an example of transmitting an SRS resource within an SRS resource set with no RRC parameters configured when supporting sDCI mTRP based on the unified TCI framework extension according to an embodiment of the present disclosure;

FIG. 12 illustrates an example of transmitting an SRS resource within an SRS resource set with no RRC parameters configured when supporting mDCI mTRP based on the unified TCI framework extension according to an embodiment of the present disclosure;

FIG. 13 illustrates an example of an SRS resource set according to an embodiment of the present disclosure;

FIG. 14 illustrates an example of an SRS resource set according to an embodiment of the present disclosure;

FIG. 15 illustrates an example of an SRS resource set when the SRS resource set is triggered according to an embodiment of the present disclosure;

FIG. 16 illustrates an example of an SRS resource set when the SRS resource set is triggered according to an embodiment of the present disclosure;

FIG. 17 illustrates an example of an SRS resource set when the SRS resource set is triggered according to an embodiment of the present disclosure;

FIG. 18 illustrates an example of a structure of a UE in a wireless communication system according to an embodiment of the present disclosure; and

FIG. 19 illustrates an example of a structure of a base station in a wireless communication system according to an embodiment of the present disclosure.

### DETAILED DESCRIPTION

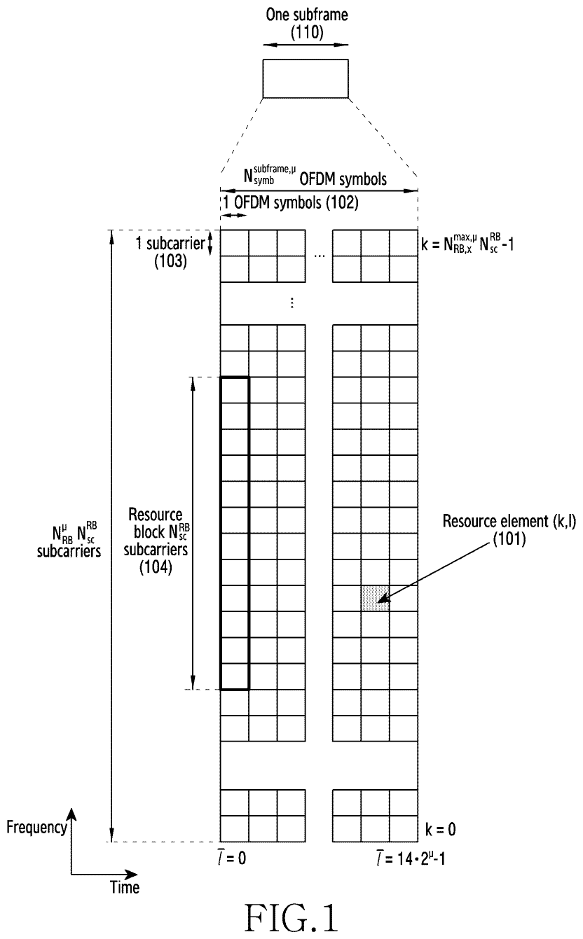

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery lifetime such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

### [NR Time-Frequency Resources]

Hereinafter, a frame structure of a 5G system will be described in more detail with reference to the accompanying drawings.

FIG. 1 illustrates an example of a basic structure of a time-frequency domain in a wireless communication system according to an embodiment of the present disclosure.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

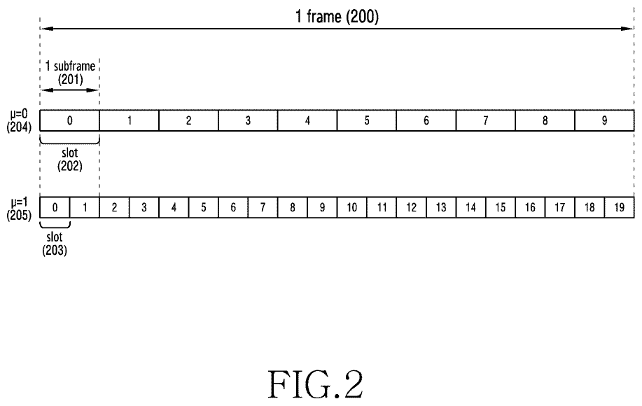

FIG. 2 illustrates an example of a structure of a frame, a subframe, and a slot in a wireless communication system according to an embodiment of the present disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (i.e., the number of symbols per one slot is N_{symb}^{slot}=14). One subframe 201 may include one or multiple slots 202 and 203, and the number of slots 202 and 203 per one subframe 201 may vary depending on configuration values μ for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{subframe,μ} may differ depending on the subcarrier spacing configuration value μ, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

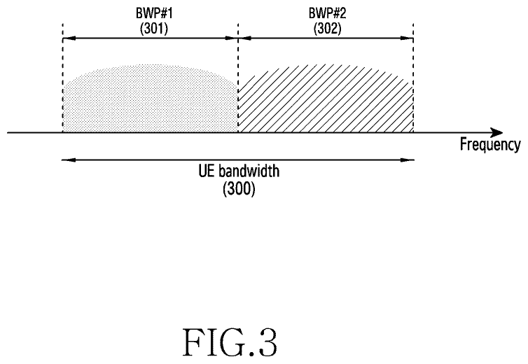

FIG. 3 illustrates an example of a bandwidth part configuration in a wireless communication system according to an embodiment of the present disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE and may configure the following pieces of information with regard to each bandwidth part as given in Table 2 below.

TABLE 2

| | |
|---|---|
| BWP ::= | SEQUENCE { |
| bwp-Id | BWP-Id, |
| (bandwidth part identifer) | |
| locationAndBandwidth | INTERGER (1..65536), |
| (bandwidth part location) | |
| subcarrierSpacing | ENUMERATED |
| | {n0, n1, n2, n3, n4, n5}, |
| (subcarrier spacing) | |
| cyclicPrefix | ENUMERATED { extended } |
| (cyclic prefix) | |
| } | |

Of course, the information configured for the UE with regard to the bandwidth configuration is not limited by Table 2, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

According to various embodiments of the disclosure, the bandwidth part-related configuration supported by 5G may be used for various purposes.

According to some embodiments, the bandwidth part configuration may be used to support the case where the bandwidth supported by the UE is smaller than the system bandwidth. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (i.e., CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (TBWP) required during a bandwidth part change are specified in standards, and may be defined as given in Table 3 below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+TBWP and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI indicating a bandwidth part change will indicate a slot offset (K0 or K2) value smaller than the bandwidth part change delay time (TBWP).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [Unified TCI State]

Hereinafter, the single TCI state indication and activation method based on the unified TCI scheme is described. The unified TCI scheme may indicate a scheme for unifying and managing the transmission and reception beam management scheme divided into the TCI state scheme used in the downlink reception and the spatial relation information scheme used in the uplink transmission of the UE in the existing Rel-15/16, as the TCI state. Hence, when indicated from the base station based on the unified TCI scheme, the UE may perform beam management using the TCI state even for the uplink transmission. If the UE is configured with higher layer signaling TCI-State having higher layer signaling tci-stateId-r17 from the base station, the UE may perform an operation based on the unified TCI scheme by using the corresponding TCI-State. TCI-State may include two types of a joint TCI state or a separate TCI state.

The first type is the joint TCI state, and the UE may be indicated from the base station with the TCI state to apply for the uplink transmission and the downlink reception through one TCI-State. If the UE is indicated with TCI-State based on the joint TCI state, the UE may be indicated with a parameter to use for downlink channel estimation by using a reference signal (RS) corresponding to qcl-Type1 of the corresponding joint TCI state based TCI-State, and a parameter to use as a downlink reception beam or a reception filter by using an RS corresponding to qcl-Type2. If the UE is indicated with TCI-State based on the joint TCI state, the UE may be indicated with a parameter to use as an uplink transmission beam or a transmission filter by using the RS corresponding to qcl-Type2 of the corresponding joint DL/UL TCI state based TCI-State. Here, when the UE is indicated with the joint TCI state, the UE may apply the same beam to the uplink transmission and the downlink reception.

The second type is the separate TCI state, and the UE may be indicated from the base station individually with a UL TCI state to apply for the uplink transmission and a DL TCI state to apply for the downlink reception. If the UE is indicated with the UL TCI state, the UE may be indicated with a parameter to use as an uplink transmission beam or a transmission filter by using a reference RS or a source RS configured in the corresponding UL TCI state. If the UE is indicated with the DL TCI state, the UE may be indicated with a parameter to use for downlink channel estimation by using the RS corresponding to qcl-Type1 of the corresponding DL TCI state, and a parameter to use as a downlink reception beam or a reception filter by using the RS corresponding to qcl-Type2.

If the UE is indicated with the DL TCI state and the UL TCI state together, the UE may be indicated with the parameter to use as the uplink transmission beam or the transmission filter by using the reference RS or the source RS configured in the corresponding UL TCI state, and the UE may be indicated with the parameter to use for the downlink channel estimation by using the RS corresponding to qcl-Type1 of the corresponding DL TCI state, and the parameter to use as the downlink reception beam or the reception filter using the RS corresponding to qcl-Type2. In case that the reference RSs or the source RSs configured in the DL TCI state and the UL TCI state indicated to the UE are different, the UE may individually apply the beam to the uplink transmission and the downlink reception based on the indicated UL TCI state and DL TCI state.

The UE may be configured from the base station with a maximum of 128 joint TCI states for each specific bandwidth part (BWP) in a specific cell through higher layer signaling. In addition, a maximum of 64 or 128 DL TCI states of the separate TCI state may be configured for each specific BWP in a specific cell through higher layer signaling based on a UE capability report. The DL TCI state of the separate TCI state and the joint TCI state may use the same higher layer signaling structure. For example, if 128 joint TCI states are configured and 64 DL TCI states are configured in the separate TCI state, 64 DL TCI states may be included in 128 joint TCI states.

Up to 32 or 64 UL TCI states of the separate TCI state may be configured for each specific BWP in a specific cell through higher layer signaling based on a UE capability report, the UL TCI state of the separate TCI state and the joint TCI state may use the same higher layer signaling structure, like the relationship of the DL TCI state of the separate TCI state and the joint TCI state, and the UL TCI state of the separate TCI state may use a different higher layer signaling structure from the joint TCI state and the DL TCI state of the separate TCI state.

As such, using the different or the same higher layer signaling structure may be defined in the standard, and may be distinguished through yet another higher layer signaling configured by the base station, based on a UE capability report containing information of whether to use one of the two types supported by the UE.

The UE may receive a transmission and reception beam-related indication in the unified TCI scheme by using one of the joint TCI state and the separate TCI state configured from the base station. The UE may be configured from the base station whether to use one of the joint TCI state and the separate TCI state through higher layer signaling.

The UE may receive the transmission and reception beam-related indication by using one scheme selected from the joint TCI state and the separate TCI state through higher layer signaling. Here, the transmission and reception beam indication method from the base station may include two methods of a MAC-CE based indication method and a MAC-CE-based activation and DCI-based indication method.

In case that the UE receives the transmission and reception beam-related indication by using a scheme of the joint TCI state through the higher layer signaling, the UE may perform a transmission and reception beam application operation by receiving a MAC-CE indicating the joint TCI state from the base station, and the base station may schedule, for the UE, reception of a PDSCH including the corresponding MAC-CE through the PDCCH. If the MAC-CE includes one joint TCI state, the UE may determine an uplink transmission beam, a transmission filter, a downlink reception beam, or a reception filter by using the joint TCI state indicated from 3 ms after PUCCH transmission including HARQ-ACK information indicating whether the PDSCH including the corresponding MAC-CE is successfully received or not. If the MAC-CE includes two or more joint TCI states, the UE may identify the plurality of the joint TCI states indicated through the MAC-CE corresponding to respective codepoints of the TCI state field of DCI format 1_1 or 1_2 and activate the indicated joint TCI state, from 3 ms after PUCCH transmission including HARQ-ACK information indicating whether the PDSCH including the corresponding MAC-CE is successfully received or not. Thereafter, the UE may receive DCI format 1_1 or 1_2 and apply one joint TCI state indicated by the TCI state field of the corresponding DCI to the uplink transmission and downlink reception beams. Here, DCI format 1_1 or 1_2 may include downlink data channel scheduling information (with DL assignment) or may not include the same (without DL assignment).

In case that the UE receives the transmission and reception beam-related indication by using a scheme of the separate TCI state through higher layer signaling, the UE may perform the transmission and reception beam application operation by receiving the MAC-CE indicating the separate TCI state from the base station, and the base station may schedule, for the UE, reception of a PDSCH including the corresponding MAC-CE through the PDCCH. If the MAC-CE includes one separate TCI state set, the UE may determine an uplink transmission beam, a transmission filter, a downlink reception beam, or a reception filter by using the separate TCI states included in the separate TCI state set indicated from 3 ms after PUCCH transmission including HARQ-ACK information indicating whether the corresponding PDSCH is successfully received or not. Here, the separate TCI state set may indicate one or more separate TCI states of one codepoint of the TCI state field in DCI format 1_1 or 1_2. In addition, one separate TCI state set may include one DL TCI state, one UL TCI state, or one DL TCI state and one UL TCI state. If the MAC-CE includes two or more separate TCI state sets, the UE may identify the plurality of the separate TCI state sets indicated through the MAC-CE corresponding to respective codepoints of the TCI state field of DCI format 1_1 or 1_2 and activate the indicated separate TCI state set, from 3 ms after PUCCH transmission including HARQ-ACK information indicating whether the corresponding PDSCH is successfully received or not. Here, each codepoint of the TCI state field of DCI format 1_1 or 1_2 may indicate one DL TCI state, one UL TCI state, or one DL TCI state and one UL TCI state. The UE may receive DCI format 1_1 or 1_2 and apply the separate TCI state set indicated by the TCI state field of the corresponding DCI to the uplink transmission and downlink reception beams. Here, DCI format 1_1 or 1_2 may include downlink data channel scheduling information (with DL assignment) or may not include the same (without DL assignment).

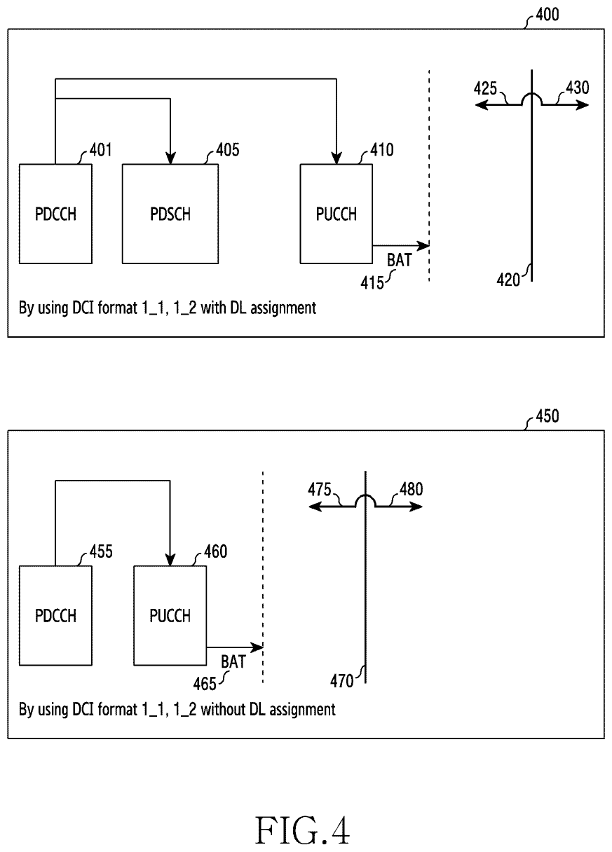

FIG. 4 illustrates an example of a beam application time that may be considered when using a unified TCI scheme in a wireless communication system according to an embodiment of the present disclosure.

As described above, the UE may receive DCI format 1_1 or 1_2 including downlink data channel scheduling information (with DL assignment) or not including the same (without DL assignment) from the base station, and apply one joint TCI state or separate TCI state set indicated by the TCI state field of the corresponding DCI to the uplink transmission and downlink reception beams.
DCI format 1_1 or 1_2 with DL assignment (indicated by reference numeral, for example, 400): In case that the UE receives, from the base station, DCI format 1_1 or 1_2 including the downlink data channel scheduling information (indicated by reference numeral, for example, 401) to indicate one joint TCI state or separate TCI state set based on the unified TCI scheme, the UE may receive a PDSCH scheduled based on the received DCI (indicated by reference numeral 405), and transmit a PUCCH including HARQ-ACK indicating whether reception of the DCI and the PDSCH is successful (indicated by reference numeral 410). Here, the HARQ-ACK may include success or failure of the DCI and the PDSCH both, the UE may transmit NACK in case of not receiving at least one of the DCI and the PDSCH, and the UE may transmit ACK in case of successfully receiving both the DCI and the PDSCH.
DCI format 1_1 or 1_2 without the DL assignment (indicated by reference numeral, for example, 450): In case that the UE receives, from the base station, DCI format 1_1 or 1_2 not including the downlink data channel scheduling information (indicated by reference numeral, for example, 455) to indicate one joint TCI state or separate TCI state set based on the unified TCI scheme, the UE may assume at least one combination of the following for the corresponding DCI:
   including CRC scrambled using CS-RNTI;
   every bit allocated to all fields used as redundancy version (RV) fields has a value of 1;
   every bit allocated to all fields used as a modulation and coding scheme (MCS) field has a value of 1;
   every bit allocated to all fields used as a new data indication (NDI) field has a value of 1; or
   every bit allocated to a frequency domain resource allocation (FDRA) field has a value of 0 for FDRA type 0, every bit allocated to the FDRA field has a value of 1 for FDRA type 1, and every bit allocated to the FDRA field has a value of 0 for FDRA scheme dynamicSwitch.

The UE may transmit a PUCCH including the HARQ-ACK indicating reception success or failure of DCI format 1_1 or 1_2 for which the above details are assumed (indicated by reference numeral 460).
With respect to both DCI format 1_1 or 1_2 with the DL assignment 400 and without the DL assignment 450, if a new TCI state indicated by the DCI 401 and 455 is already indicated and identical to the TCI state applied to the uplink transmission and downlink reception beams, the UE may maintain the existing TCI state. If the new TCI state is different from the existing indicated TCI state, the UE may determine an application time of the joint TCI state or separate TCI state set that can be indicated from the TCI state field included in the DCI, as a time 430 or 480 after a first slot 420 or 470 after a time corresponding to a beam application time (BAT) 415 or 465 after the PUCCH transmission, and may use the existing indicated TCI state up to a time 425 or 475 before the corresponding slot (e.g., 420 or 470).
With respect to both DCI format 1_1 or 1_2 with the DL assignment 400 and without the DL assignment 450, the BAT may be configured with higher layer signaling based on UE capability report information using a specific number of OFDM symbols. Further, numerology of the BAT and the first slot after the BAT may be determined based on the smallest numerology among all the cells to which the joint TCI state or separate TCI state set indicated by the DCI is applied.

The UE may apply one joint TCI state indicated through the MAC-CE or the DCI with respect to receiving CORESETs connected to every UE-specific search space, receiving the PDSCH scheduled with the PDCCH transmitted from the corresponding CORESET and transmitting the PUSCH, and transmitting every PUCCH resource.

In case that one separate TCI state set indicated through the MAC-CE or the DCI includes one DL TCI state, the UE may apply the one separate TCI state set with respect to receiving CORESETs connected to every UE-specific search space, and receiving the PDSCH scheduled with the PDCCH transmitted from the corresponding CORESET, and may apply the one separate TCI state set to every PUSCH and PUCCH resource based on the existing indicated UL TCI state.

In case that one separate TCI state set indicated through the MAC-CE or the DCI includes one UL TCI state, the UE may apply the one separate TCI state set to every PUSCH and PUCCH resource, and apply the one separate TCI state set, based on the existing DL TCI state indicated, with respect to receiving CORESETs connected to every UE-specific search space, and receiving the PDSCH scheduled with the PDCCH transmitted from the corresponding CORESET.

In case that one separate TCI state set indicated through the MAC-CE or the DCI includes one DL TCI state and one UL TCI state, the UE may apply the DL TCI state to receiving CORESETs connected to every UE-specific search space, and receiving the PDSCH scheduled with the PDCCH transmitted from the corresponding CORESET, and may apply the UL TCI state to every PUSCH and PUCCH resource.

### [Unified TCI State MAC-CE]

The following describes a method for single-TCI state indication and activation based on the unified TCI scheme. Starting three slots after the UE has received scheduling of a PDSCH containing the following MAC-CE from the base station and has transmitted an HARQ-ACK for the corresponding PDSCH to the base station, the UE may interpret each code point of the TCI state field in DCI format 1_1 or 1_2, based on the information in the MAC-CE received from the base station. That is, the UE may activate each entry in the MAC-CE received from the base station to each code point in the TCI state field in DCI format 1_1 or 1_2.

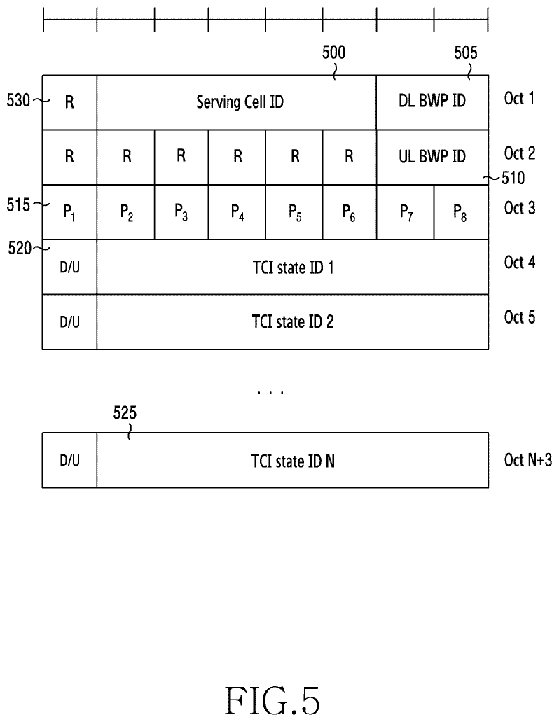

FIG. 5 illustrates another example of a MAC-CE structure for activation and indication of a joint TCI state or separate DL or UL TCI state in a wireless communication system according to an embodiment of the present disclosure.

The meaning of each field within the corresponding MAC-CE structure may be as follows.
Serving Cell ID 500: This field may indicate a serving cell to which the corresponding MAC-CE is applied to. This field may have a length of 5 bits. If the serving cell indicated by this field is included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to every serving cell included in one or more of the lists among simultaneousU-TCI-UpdateList1, simultaneousU-TCI-UpdateList2, simultaneousU-TCI-UpdateList3, or simultaneousU-TCI-UpdateList4 that contain the serving cell indicated by this field.
DL BWP ID 505: This field may indicate a DL BWP to which the corresponding MAC-CE is applied, and the meaning of each codepoint in this field may correspond to each codepoint of the bandwidth part indicator in the DCI. This field may have a length of two bits.
UL BWP ID 510: This field may indicate a UL BWP to which this MAC-CE is applied, and the meaning of each code point in this field may correspond to each code point of the bandwidth part indicator in the DCI. This field may have a length of two bits.
Pi 515: This field may indicate whether each codepoint of the TCI state field in DCI format 1_1 or 1_2 has multiple TCI states or a single TCI state. If Pi has a value of 1, this means that the corresponding i-th codepoint has multiple TCI states, and this may be understood as meaning that the codepoint may contain a separate DL TCI state and a separate UL TCI state. If Pi has a value of 0, this means that the corresponding i-th codepoint has a single TCI state, and this may be understood as meaning that the codepoint may contain one of a joint TCI state, a separate DCI TCI state, or a separate UL TCI state.
D/U 520: This field may indicate whether the TCI state ID field within the same octet is a joint TCI state, a separate DL TCI state, or a separate UL TCI state. If this field has a value of 1, the TCI state ID fields within the same octet may be joint TCI states or separate DL TCI states. If this field has a value of 0, the TCI state ID fields within the same octet may be separate UL TCI states.
TCI state ID 525: This field may indicate a TCI state that can be determined using the higher layer signaling TCI-StateId. If the D/U field is configured to have a value of 1, this field may be used to represent the TCI-StateId, which may be represented by 7 bits. If the D/U field is configured to have a value of 0, the most significant bit (MSB) of this field may be considered a reserved bit, and the remaining 6 bits may be used to represent the UL-TCIState-Id which is higher layer signaling. The maximum number of TCI states that may be activated is 8 for joint TCI states and 16 for separate DL or UL TCI states.
R: refers to the reserved bit, which may be configured to have a value of 0.

For the MAC-CE structure of FIG. 5 described above, the UE may include, in the corresponding MAC-CE structure, a third octet containing the fields P1, P2, . . . , P8 in FIG. 5, regardless of whether the unifiedTCI-StateType-r17 in MIMOparam-r17 in the higher layer signaling, ServingCellConfig, is configured as joint or separate. In such a case, the UE may perform TCI state activation by using a fixed MAC-CE structure, regardless of the higher layer signaling configured from the base station. For example, for the MAC-CE structure of FIG. 5 described above, the UE may omit the third octet within FIG. 5 containing the fields P1, P2, . . . , P8 when the unifiedTCI-StateType-r17 within MIMOparam-r17 within the higher layer signaling, ServingCellConfig, is configured as joint. In such a case, the UE may save a maximum of 8 bits of the payload of the corresponding MAC-CE according to the higher layer signaling configured from the base station. Further, the D/U fields located in the first bit of the fourth octet in FIG. 5 may all be considered R fields, and the corresponding R fields may all be configured as zero bits.

### [PDCCH: Regarding DCI]

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and thereby may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

TABLE 4

| | |
|---|---|
| - | Identifier for DCI formats − [1] bit |
| - | Frequency domain resource assignment |
| | −[┌log₂(N_{RB}^{UL,BWP} (N_{RB}^{UL,BWP} + 1)/2)┐ ] |

bits

| | |
|---|---|
| - | Time domain resource assignment − X bits |
| - | Frequency hopping flag − 1 bit. |
| - | Modulation and coding scheme − 5 bits |
| - | New data indicator − 1 bit |
| - | Redundancy version − 2 bits |
| - | HARQ process number − 4 bits |
| - | Transmit power control (TPC) command for |
| | scheduled PUSCH − [2] bits |
| - | Uplink/supplementary uplink (UL/SUL) indicator − 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
      * For resource allocation type 0, ┌N_{RB}^{UL,BWP}/P┐ bits
      * For resource allocation type 1, ┌log2(N_{RB}^{UL,BWP}(N_{RB}^{UL,BWP} + 1)/2)┐ bits
  - Time domain resource assignment - 1, 2, 3, or 4 bits
  - Virtual resource block (VRB)-to-physical resource block (PRB) mapping - 0 or 1
bit, only for resource allocation type 1.
      * 0 bit if only resource allocation type 0 is configured;
      * 1 bit otherwise.
  - Frequency hopping flag - 0 or 1 bit, only for resource allocation type 1.
      * 0 bit if only resource allocation type 0 is configured;
      * 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
      * 1 bit for semi-static HARQ-ACK codebook;
      * 2 bits for dynamic HARQ-ACK codebook with single HARQ-ACK
      codebook.
  - 2nd downlink assignment index - 0 or 2 bits
      * 2 bits for dynamic HARQ-ACK codebook with two HARQ-ACK sub-
      codebooks;
      * 0 bit otherwise.
  - TPC command for scheduled PUSCH - 2 bits
  $‐ SRS resource indicator - ⌈ {log}_{2} ( {\sum }_{k = 1}^{{L}_{max} \sum } ( \begin{matrix}{N}_{SRS} \\ k\end{matrix} ) ( ) ) ¬ ¬ ⌉ or ⌈ {log}_{2} ( {N}_{SRS} ) ⌉ bits$
      $* ⌈ {log}_{2} ( {\sum }_{k = 1}^{{L}_{max} \sum } ( \begin{matrix}{N}_{SRS} \\ k\end{matrix} ) ( ) ) ¬ ¬ ⌉ bits for non ‐ codebook based PUSCH$
      transmission;
      * ┌log₂(N_{SRS})┐ bits for codebook based PUSCH transmission.
  - Precoding information and number of layers - up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8 bits
  - Phase tracking reference signal (PTRS)-demodulation reference signal (DDMRS)
association - 0 or 2 bits.
  - beta offset indicator - 0 or 2 bits
  - DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

TABLE 6

| | |
|---|---|
| - | Identifier for DCI formats − [1] bit |
| - | Frequency domain resource assignment |
| | −[┌log₂(N_{RB}^{DL,BWP} (N_{RB}^{DL,BWP} + 1)/2)┐ ] |

bits

| | |
|---|---|
| - | Time domain resource assignment − X bits |
| - | VRB-to-PRB mapping − 1 bit. |
| - | Modulation and coding scheme − 5 bits |
| - | New data indicator − 1 bit |
| - | Redundancy version − 2 bits |
| - | HARQ process number − 4 bits |
| - | Downlink assignment index − 2 bits |
| - | TPC command for scheduled PUCCH − [2] bits |
| - | Physical uplink control channel (PUCCH) resource indicator − 3 bits |
| - | PDSCH-to-HARQ feedback timing indicator − [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

TABLE 7

| | |
|---|---|
| - | Carrier indicator − 0 or 3 bits |
| - | Indicator for DDCI formats − [1] bits |
| - | Bandwidth part indicator − 0, 1 or 2 bits |
| - | Frequency domain resource assignment |
| | * For resource allocation type 0, ┌N_{RB}^{DL,BWP} /P┐bits |
| | * For resource allocation type 1, ┌log₂(N_{RB}^{DL,BWP} |
| | (N_{RB}^{DL,BWP} + 1)/2)┐ bits |
| - | Time domain resource assignment −1, 2, 3, or 4 bits |
| - | VRB-to-PRB mapping − o or 1 bit, only for resource allocation type 1. |
| | * 0 bit if only resource allocation type 0 is configured; |
| | * 1 bit otherwise. |
| - | Physical resource block (PRB) bundling size indicator − 0 or 1 bit |
| - | Rate matching indicator − 0, 1, or 2 bits |
| - | Zero power (ZP) channel state information (CSI)-reference |

signal (RS) trigger − 0, 1, or 2 bits
For transport block 1:

| | |
|---|---|
| - | Modulation and coding scheme − 5 bits |
| - | New data indicator − 1 bit |
| - | Redundancy version − 2 bits |

For transport block 2:

| | |
|---|---|
| - | Modulation and coding scheme − 5 bits |
| - | New data indicator − 1 bit |
| - | Redundancy version − 2 bits |
| - | HARQ process number − 4 bits |
| - | Downlink assignment index − 0 or 2 or 4 bits |
| - | TPC command for scheduled PUCCH − 2 bits |
| - | PUCCH resource indicator − 3 bits |
| - | PDSCH-to-HARQ_feedback timing indicator − 3 bits |
| - | Antenna ports − 4, 5 or 6 bits |
| - | Transmission configuration indication − 0 or 3 bits |
| - | SRS request − 2 bits |
| - | CBG transmission information − 0, 2, 4, 6, or 8 bits |
| - | CBG flushing out information − 0 or 1 bit |
| - | DMRS sequence initialization − 1 bit |

### [PDCCH: CORESET, REG, CCE, and Search Space]

Hereinafter, a downlink control channel in a 5G communication system will be described in more detail with reference to the accompanying drawings.

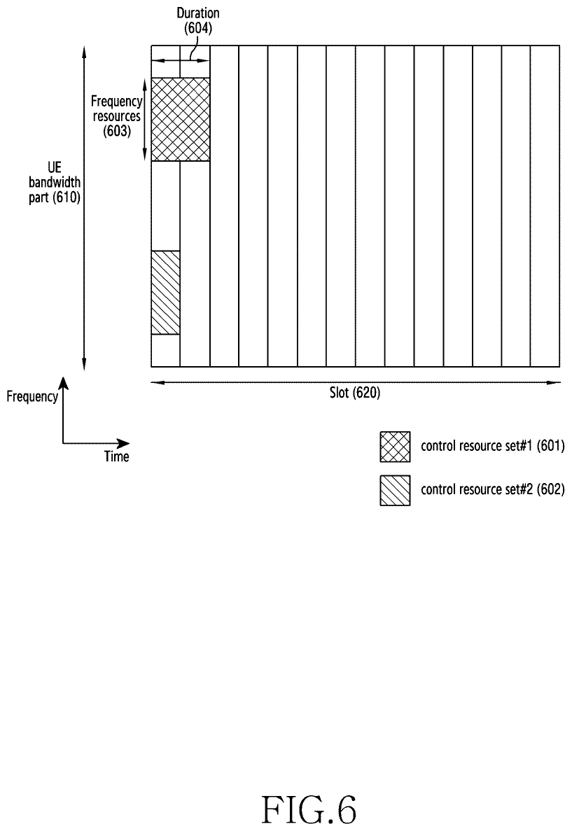

FIG. 6 illustrates an example of a control resource set (CORESET) used to transmit a downlink control channel in a 5G wireless communication system according to an embodiment of the present disclosure.

FIG. 6 illustrates an example in which a UE bandwidth part 610 is configured along the frequency axis, and two control resource sets (control resource set #1 601 and control resource set #2 602) are configured within one slot 620 along the time axis. The control resource sets 601 and 602 may be configured in a specific frequency resource (e.g., 610) within the entire UE bandwidth part 403 along the frequency axis. The control resource sets 601 and 602 may be each configured as one or multiple OFDM symbols along the time domain, and the number of the OFDM symbols may be defined as a control resource set duration 604. Referring to the example illustrated in FIG. 6, control resource set #1 601 is configured to have a control resource set duration corresponding to two symbols, and control resource set #2 602 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, this information may include the following pieces of information given in Table 8 below.

TABLE 8

| | |
|---|---|
| ConControlResourceSet ::= | SEQUENCE { |

-- Corresponds to L1 parameter ′CORESET-ID′

| | |
|---|---|
| controlResourceSetId | ControlResourceSetId, |

(control resource set identity))

| | |
|---|---|
| frequencyDomainResources | BIT STRING (SIZE (45)), |

(frequency domain resource allocation information)

| | |
|---|---|
| duration | INTEGER (1..maxCoReSetDuration), |

(time domain resource allocation information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |
| (REG bundle size) | |
| precoderGranularity | ENUMERATED {sameAsReg-bundle, |
| allContiguousRBs}, | |
| interleaverSize | ENUMERATED {n2, n3, n6} |
| (interleaver size) | |
| shiftIndex | INTEGER(0..maxNrofPhysicalResourceBlocks-1) |
| | OPTIONAL |
| (interleaver shift) | |
| }, | |
| nonInterleavd | NULL |
| }, | |
| tci-StatesPDCCH | SEQUENCE(SIZE (1..maxNrofTCI-StatesPDCC |
| H)) OF TCI-StateId | OPTIONAL, |

(QCL configuration information)

| | |
|---|---|
| tci-PresentInDCI | ENUMERATED {enabled} |
| | OPTIONAL, -- Need S |
| } | |

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding CORESET.

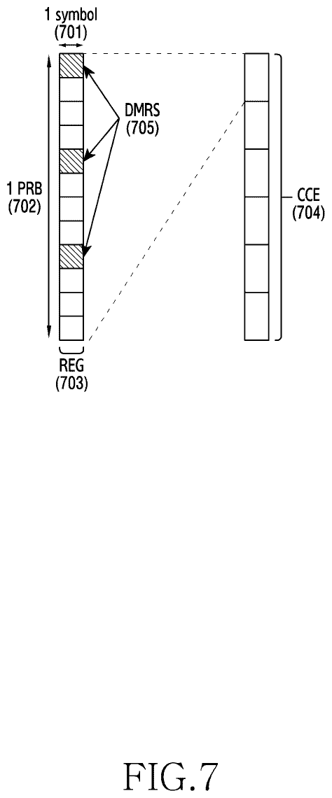

FIG. 7 illustrates an example of a structure of a downlink control channel in a wireless communication system according to an embodiment of the present disclosure.

According to FIG. 7, the basic unit of time and frequency resources constituting a control channel may be referred to as a resource element group (REG) 703, and the REG 703 may be defined by one OFDM symbol 701 along the time axis and one physical resource block (PRB) 702, that is, 12 subcarriers, along the frequency axis. The base station may configure a downlink control channel allocation unit by concatenating the REGs 703.

Provided that the basic unit of downlink control channel allocation in 5G is a control channel element (CCE) 704 as illustrated in FIG. 7, one CCE 704 may include multiple REGs 703. To describe the REG 703 illustrated in FIG. 7, for example, the REG 703 may include 12 REs, and if one CCE 704 includes six REGs 703, one CCE 704 may then include 72 REs. A downlink control resource set, once configured, may include multiple CCEs 704, and a specific downlink control channel may be mapped to one or multiple CCEs 704 and then transmitted according to the aggregation level (AL) in the control resource set. The CCEs 704 in the control resource set are distinguished by numbers, and the numbers of CCEs 704 may be allocated according to a logical mapping scheme.

The basic unit of the downlink control channel illustrated in FIG. 7, that is, the REG 703, may include both REs to which DCI is mapped, and an area to which a reference signal (DMRS 705) for decoding the same is mapped. As in FIG. 7, three DMRSs 705 may be transmitted inside one REG 703. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the information configured for the UE by the base station may include the following pieces of information in Table 9 below.

TABLE 9

| | |
|---|---|
| SearchSpace := | SEQUENCE { |

```
    -- Identity of the search space. SearchSpaceId = 0 identifies the SearchSpace
  configured via PBCH (MIB) or ServingCellConfigCommon.
```

| | |
|---|---|
| searchSpaceId | SearchSpaceId, |
| (search space identity) | |
| controlResourceSetId | ControlResourceSetId, |
| (control resource set identity) | |
| monitoringSlotPeriodicityAndOffset | CHOICE { |
| (monitoring slot level periodicity) | |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | |

OPTIONAL,

| | |
|---|---|
| duration (monitoring duration) | INTEGER (2...2559) |
| monitoringSymbolsWithinSlot | BIT STRING (SIZE (14)) |

OPTIONAL,

| | |
|---|---|
| (monitoring symbols within slot) | |
| nrofCandidates | SEQUENCE { |

(number of PDCCH candidates for each aggregation level)

| | |
|---|---|
| aggregationLevel1 | ENUMERATED {n0, n1, n2 n3, n4, |
| | n5, n6, n8}, |
| aggregationLevel2 | ENUMERATED {n0, n1, n2 n3, n4, |
| | n5, n6, n8}, |
| aggregationLevel 4 | ENUMERATED {n0, n1, n2 n3, n4, |
| | n5, n6, n8}, |
| aggregationLevel8 | ENUMERATED {n0, n1, n2 n3, n4, |
| | n5, n6, n8}, |
| aggregationLevel16 | ENUMERATED {n0, n1, n2 n3, n4, |
| | n5, n6, n8}, |
| }, | |
| searchSpaceType | CHOICE { |
| (search space type) | |

-- Configures this search space as common search space (CSS) and DCI

| | |
|---|---|
| formats to monitor. | |
| common | SEQUENCE { |
| (common search space) | |
| } | |
| ue-Specific | SEQUENCE { |
| (UE-specific search space) | |

-- Indicates whether the UE monitors in this USS for DCI formats 0-0

| | |
|---|---|
| and 1-0 or for formats 0-1 and 1-1. | |
| formats | ENUMERATED {formats0-0- |
| And-1-0, formats0-1-And-1-1}, | |
| ... | |
| } | |

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Of course, the combinations of DCI formats and RNTIs monitored in a common search space are not limited to the examples given below:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

Combinations of DCI formats and RNTIs given below may be monitored in a UE-specific search space. Of course, the combinations of DCI formats and RNTIs monitored in a UE-specific search space are not limited to the examples given below:
DCI format 0_0/1_0 with CRC scrambled by C-RNTI, CS-RNTI, TC-RNTI;
and/or
DCI format 1_0/1_1 with CRC scrambled by C-RNTI, CS-RNTI, TC-RNTI.

The RNTIs enumerated above may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and
Transmit power control for SRS RNTI (TPC-SRS-RNTI): used to indicate a power control command regarding an SRS.

The DCI formats enumerated above may follow the definitions given in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level;
n_{Cl}: carrier index;
N_{CCE,p}: total number of CCEs existing in control resource set p;
n_{s,f}^{μ}: slot index;
M_{s,max}^{(L)}: number of PDCCH candidates at aggregation level L;
m_{s,n}_{_{CI}}=0, . . . , M_{s,max}^{(L)}−1: PDCCH candidate index at aggregation level L;
i=0, . . . , L−1;

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, D=65537; and
n_{RNTI}: UE identity.

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI

or ID configured for the UE by the base station) and the time index in the case of a UE-specific search space.

In a 5G system, multiple search space sets may be configured by different parameters (for example, parameters in Table 9), and the group of search space sets monitored by the UE at each timepoint may differ accordingly. For example, search space set #1 may be configured at X-slot periodicity, and search space set #2 may be configured at Y-slot periodicity. If X and Y are different, the UE may monitor both search space set #1 and search space set #2 in a specific slot and may monitor one of search space set #1 and search space set #2 in another specific slot.

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE and may also configure as least one SRS resource set with regard to each SRS configuration. As an example, the base station and the UE may exchange upper signaling information as follows, in order to transfer information regarding the SRS resource set:
srs-ResourceSetId: an SRS resource set index;
srs-ResourceIdList: a set of SRS resource indices referred to by SRS resource sets;
resourceType: time domain transmission configuration of SRS resources referred to by SRS resource sets, and may be configured as one of “periodic,” “semi-persistent,” and “aperiodic.” If configured as “periodic” or “semi-persistent,” associated CSI-RS information may be provided according to the place of use of SRS resource sets. If configured as “aperiodic,” an aperiodic SRS resource trigger list/slot offset information may be provided, and associated CSI-RS information may be provided according to the place of use of SRS resource sets;
usage: a configuration regarding the place of use of SRS resources referred to by SRS resource sets, and may be configured as one of “beamManagement,” “codebook,” “nonCodebook,” and “antennaSwitching.”; and
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. In addition, the individual configuration information regarding SRS resources may include time domain transmission configuration of SRS resources, and may be configured as one of “periodic,” “semi-persistent,” and “aperiodic.” The time domain transmission configuration of SRS resources may be limited to have the same time domain transmission configuration as the SRS resource set including the SRS resources. If the time domain transmission configuration of SRS resources is configured as “periodic” or “semi-persistent,” the time domain transmission configuration may further include an SRS resource transmission cycle and a slot offset (for example, periodicity AndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicity AndOffset configured for the SRS resource. In addition, the spatial domain transmission filter applied to the transmitted SRS resource may refer to spatial relation info configured for the SRS resource, or may refer to associated CSI-RS information configured for the SRS resource set including to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent.” Intra-slot time-frequency domain resource mapping of the transmitted SRS resource follows resource mapping information configured for the SRS resource, and slot mapping, including the transmission cycle and slot offset, follows periodicity AndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If spatial relation info is configured for the SRS resource, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “beamManagement,” the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 11

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } OPTIONAL, -- Need R |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, 2n, n4}, |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED |
| | { neither, groupHopping, sequenceHopping }, |
| resourceType | CHOICE { |
| aperiodic | SEQUENCE { |
| ... | |
| }, | |
| semi-persistent | SEQUENCE { |
| periodicityAndOffset-sp | SRS-PeriodicityAndOffset, |
| ... | |
| }, | |
| periodic | SEQUENCE { |
| periodicityAndOffset-p | SRS-PeriodicityAndOffset, |
| ... | |
| } | |
| }, | |
| sequenceId | INTEGER (0..1023), |
| spatialRelationInfo | SRS-SpatialRelationInfo |
| OPTIONAL, -- Need R | |
| ... | |
| } | |

Configuration information spatialRelationInfo in Table 11 above may be applied, with reference to one reference signal, to a beam used for SRS transmission corresponding to beam information of the corresponding reference signal. For example, configuration of spatialRelationInfo may include information as in Table 12 below.

TABLE 12
SRS-SpatialRelationInfo ::= SEQUENCE {

| | | |
|---|---|---|
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |
| } | |
| } | |
| } | |

Referring to the spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index,” the UE may apply the reception beam which was used to receive the SS/PBCH block corresponding to ssb-Index as the transmission beam for the corresponding SRS transmission. If upper signaling referenceSignal has a configured value of “csi-RS-Index,” the UE may apply the reception beam which was used to receive the CSI-RS corresponding to csi-RS-Index as the transmission beam for the corresponding SRS transmission. If upper signaling referenceSignal has a configured value of “ssb-Index,” the UE may apply the reception beam which was used to receive the SS/PBCH block corresponding to ssb-Index as the transmission beam for the corresponding SRS transmission.

### [SRS: Antenna Switching]

In the following, SRS for antenna switching is described.

SRS transmitted from a UE may be utilized by a base station for the acquisition of DL channel state information (CSI) (e.g., DL CSI acquisition). As a specific example, in a single cell or multi cell (e.g., carrier aggregation (CA)) situation) based on time division duplex (TDD), the base station (BS) may schedule the transmission of SRS for the user equipment (UE) and then measure the SRS transmitted from the UE. In this case, assuming reciprocity between downlink (DL) and uplink (UL) channels, the base station may consider the uplink channel information estimated based on the SRS transmitted from the UE as the downlink channel information, and may use the same to schedule the downlink signal/channel for the UE. In this case, the UE may be configured from the base station with the usage of the SRS for the downlink channel information acquisition through antenna switching.

For example, according to a specification (e.g., 3gpp TS38.214), the usage of the SRS may be configured for the base station and/or the UE by using a higher layer parameter (e.g., usage of the RRC parameter SRS-ResourceSet). Here, the usage of the SRS may be configured for beam management use, codebook transmission use, non-codebook transmission use, antenna switching use, or the like.

As described above, in case that the UE is configured from the base station with the usage parameter in the higher layer signaling SRS-ResourceSet configured as “antennaSwitching,” the UE may receive at least one higher layer signaling configuration from the base station according to the reported UE capability. In this case, the UE may report “supportedSRS-TxPortSwitch” through a UE capability, the value of which may be as shown below. In the following, “mTnR” may refer to the UE capability to support transmission through m antennas and reception through n antennas:
“t1r2”: A UE capability report value having a meaning that the UE is capable of performing 1T2R operation;
“t1r1-t1r2”: A UE capability report value having a meaning that the UE is capable of performing 1T1R or 1T2R operation;
“t2r4”: A UE capability report value having a meaning that the UE is capable of performing 2T4R operation;
“t1r4”: A UE capability report value having a meaning that the UE is capable of performing 1T4R operation;
“t1r6”: A UE capability report value having a meaning that the UE is capable of performing 1T6R operation;
“t1r8”: A UE capability report value having a meaning that the UE is capable of performing 1T8R operation;
“t2r6”: A UE capability report value having a meaning that the UE is capable of performing 2T6R operation;
“t2r8”: A UE capability report value having a meaning that the UE is capable of performing 2T8R operation;
“t4r8”: A device capability report value having a meaning that the UE is capable of performing 4T8R operation;
“t1r1-t1r2-t1r4”: A device capability report value having a meaning that the UE is capable of performing 1T1R, 1T2R, or 1T4R operation;
“t1r4-t2r4”: A device capability report value having a meaning that the UE is capable of performing 1T4R or 2T4R operation;
“t1r1-t1r2-t2r2-t2r2-t2r4”: A UE capability report value having a meaning that the UE is capable of performing 1T1R, 1T2R, 2T2R, or 2T4R operation;
“t1r1-t1r2-t2r2-t1r4-t2r4”: A UE capability report value having a meaning that the UE is capable of performing 1T1R, 1T2R, 2T2R, 1T4R, or 2T4R operation;
“t1r1”: A UE capability report value having a meaning that the UE is capable of performing 1T1R operation;
“t2r2”: A UE capability report value having a meaning that the UE is capable of performing 2T2R operation;
“t1r1-t2r2”: A UE capability report value having a meaning that the UE is capable of performing 1T1R or 2T2R operation;
“t4r4”: A device capability report value having a meaning that the UE is capable of performing 4T4R operation; and
“t1r1-t2r2-t4r4”: A device capability report value having a meaning that the UE is capable of performing 1T1R, 2T2R, or 4T4R operation.

### [1T2R]

With respect to the 1T2R operation of the UE, the UE may receive higher layer signaling configured from the base station, such as a combination including at least one of the following, and may perform the 1T2R operation accordingly.
In case that the UE has reported a part or all of the UE capability reports srs-AntennaSwitching2SP-1Periodic-r17 and srs-ExtensionAperiodicSRS-r17.
   In case that the UE has reported only srs-AntennaSwitching2SP-1Periodic-r17,
      The UE may receive, from the base station, a maximum of two SRS resource sets configured with a resourceType value of “semi-persistent” in the higher layer signaling SRS-ResourceSet, and may receive, from the base station, a maximum of one SRS resource set configured with a resourceType value of “periodic” in the higher layer signaling SRS-ResourceSet, or
      The UE may receive, from the base station, a maximum of two SRS resource sets configured with different resourceType values in the higher layer signaling SRS-ResourceSet.
      With respect to the above details, two SRS resource sets having a resourceType value of “semi-persistent” in the higher layer signaling SRS-ResourceSet may not be activated at the same time.
   With respect to the above details, each SRS resource set may contain two SRS resources transmitted in different OFDM symbols.
      With respect to the above details, each SRS resource within each SRS resource set may include one SRS port, and the SRS ports of each SRS resource within each SRS resource set may be connected to different UE antenna ports.
         For example, the SRS resource set may include a first and a second SRS resource including one SRS port, each SRS port of the first and second SRS resources may be connected to a different UE antenna port, the SRS port of the first SRS resource may be transmitted at a first OFDM symbol position, and the SRS port of the second SRS resource may be transmitted at a second OFDM symbol position. In this case, the first and second OFDM symbol positions are different from each other, but the slot positions may be the same or different from each other.
   In case that the UE has reported only srs-ExtensionAperiodicSRS-r17,
      The UE may receive, from the base station, a maximum of two SRS resource sets configured with a resourceType value of “aperiodic” in the higher layer signaling SRS-ResourceSet, and a maximum of one SRS resource set configured with a resourceType value of “periodic” or “semi-persistent” in the higher layer signaling SRS-ResourceSet, or
      The UE may receive, from the base station, a maximum of two SRS resource sets configured with different resourceType values in the higher layer signaling SRS-ResourceSet.
      In addition to the above details, if the UE receives, from the base station, two SRS resource sets configured with a resourceType value of “aperiodic” in the higher layer signaling SRS-ResourceSet, each SRS resource in the two SRS resource sets may be transmitted in the same or different OFDM symbol positions within two different slots, each SRS resource set may include one SRS port, each SRS resource in the two SRS resource sets may include one SRS resource, each SRS resource in the two SRS resource sets may include one SRS port, and the SRS ports of each SRS resource in the two SRS resource sets may be connected to different UE antenna ports.
         For example, a first SRS resource including one SRS port may be included in the first SRS resource set, a second SRS resource including one SRS port may be included in the second SRS resource set, each SRS port of the first and second SRS resources may be connected to a different UE antenna port, the SRS port of the first SRS resource may be transmitted at a first OFDM symbol position in the first slot, and the SRS port of the second SRS resource may be transmitted at a second OFDM symbol position in the second slot. In this case, the first and second OFDM symbol positions may be the same or different within each slot, but the slot positions may be different from each other.
      With respect to the above, if the UE receives, from the base station, one SRS resource set configured with a resourceType value of “aperiodic” in the higher layer signaling SRS-ResourceSet, the two SRS resources in the corresponding SRS resource set may be transmitted at different OFDM symbol positions in the same slot, and each SRS resource in the corresponding SRS resource set may include one SRS port, and the SRS ports of each SRS resource may be connected to different UE antenna ports.
         For example, the SRS resource set may include a first and a second SRS resource including one SRS port, each SRS port of the first and second SRS resources may be connected to a different UE antenna port, the SRS port of the first SRS resource may be transmitted at a first OFDM symbol position within a first slot, and the SRS port of the second SRS resource may be transmitted at a second OFDM symbol position in the same slot.
      For the above details, if the UE receives, from the base station, one SRS resource set configured with a resourceType value of “periodic” or “semi-persistent” in the higher layer signaling SRS-ResourceSet, the two SRS resources in the corresponding SRS resource set may be transmitted at different OFDM symbol positions, each SRS resource in the corresponding SRS resource set may include one SRS port, and the SRS port of each SRS resource may be connected to a different UE antenna port.
         For example, the SRS resource set may include a first and a second SRS resource including one SRS port, each SRS port of the first and second SRS resources may be connected to a different UE antenna port, the SRS port of the first SRS resource may be transmitted at a first OFDM symbol position within a first slot, and the SRS port of the second SRS resource may be transmitted at a second OFDM symbol position in the same slot.
   In case that the UE does not report srs-AntennaSwitching2SP-I Periodic-r17, the UE may receive, from the base station, a maximum of two different SRS resource sets (e.g., 0, 1, or 2) configured with a resourceType value in the higher layer signaling SRS-ResourceSet, the resourceType having a value of either “periodic” or “semi-persistent.” For example, the UE may be configured with one of the following from the base station.
      The UE does not receive an SRS resource set configured with a resourceType value of “periodic” or “semi-persistent” in the higher layer signaling SRS-ResourceSet.
      One SRS resource set configured with a resourceType value of “periodic” in the higher layer signaling SRS-ResourceSet,
      One SRS resource set configured with a resourceType value of “semi-persistent” in the higher layer signaling SRS-ResourceSet,
      In the higher layer signaling SRS-ResourceSet, there is one SRS resource set with a resourceType value of “periodic” and one SRS resource set with a resourceType value of “semi-persistent.”
      With respect to the above, two SRS resource sets configured with a resourceType value of “semi-persistent” in the higher layer signaling SRS-ResourceSet may not be activated at the same time.
      With respect to the above details, each SRS resource set may include two SRS resources, the two SRS resources may be transmitted at different OFDM symbol positions, each SRS resource within the SRS resource set may include one SRS port, and the SRS ports of each SRS resource may be connected to different UE antenna ports.
         For example, the SRS resource set may include a first and a second SRS resource including one SRS port, each SRS port of the first and second SRS resources may be connected to a different UE antenna port, the SRS port of the first SRS resource may be transmitted at a first OFDM symbol position within a first slot, and the SRS port of the second SRS resource may be transmitted at a second OFDM symbol position in the same slot.
   In case that the UE has reported srs-AntennaSwitching2SP-1Periodic-r17, the UE may receive, from the base station, a maximum of two SRS resource sets configured with resourceType value of “semi-persistent” in the higher layer signaling SRS-ResourceSet, and may receive, from the base station, a maximum of one SRS resource set configured with resourceType value of “periodic” in the higher layer signaling SRS-ResourceSet.
      With respect to the above, two SRS resource sets configured with a resourceType value of “semi-persistent” in the higher layer signaling SRS-ResourceSet may not be activated at the same time.
      With respect to the above, each SRS resource set may include two SRS resources, the two SRS resources may be transmitted at different OFDM symbol positions, each SRS resource within the SRS resource set may include one SRS port, and the SRS ports of each SRS resource may be connected to different UE antenna ports.
         In an example, the SRS resource set may include a first and a second SRS resource including one SRS port, each SRS port of the first and second SRS resources may be connected to a different UE antenna port, the SRS port of the first SRS resource may be transmitted at a first OFDM symbol position, and the SRS port of the second SRS resource may be transmitted at a second OFDM symbol position. In this case, the first and second OFDM symbol positions are different from each other, but the slot positions may be the same or different from each other.
   In case that the UE does not report only srs-ExtensionAperiodicSRS-r17, the UE may receive, from the base station, a maximum of one SRS resource set (e.g., 0 or 1) configured with a resourceType value of “aperiodic” in the higher layer signaling SRS-ResourceSet. For example, the UE may be configured with one of the following from the base station.
      The UE does not receive an SRS resource set configured with a resourceType value of “aperiodic” in the higher layer signaling SRS-ResourceSet.
      One SRS resource set configured with a resourceType value of “aperiodic” in the higher layer signaling SRS-ResourceSet
      With respect to the above, if one SRS resource set is configured, each SRS resource set may include two SRS resources, the two SRS resources may be transmitted at different OFDM symbol positions in the same slot, each SRS resource within the SRS resource set may include one SRS port, and the SRS ports of each SRS resource may be connected to different UE antenna ports.
         For example, the SRS resource set may include a first and a second SRS resource including one SRS port, each SRS port of the first and second SRS resources may be connected to a different UE antenna port, the SRS port of the first SRS resource may be transmitted at a first OFDM symbol position within a first slot, and the SRS port of the second SRS resource may be transmitted at a second OFDM symbol position in the same slot.
   In case that the UE has reported only srs-ExtensionAperiodicSRS-r17, the UE may receive, from the base station, a maximum of two SRS resource sets (e.g., 0, 1 or 2) configured with a resourceType value of “aperiodic” in the higher layer signaling SRS-ResourceSet. For example, the UE may be configured with one of the following from the base station.
      The UE does not receive an SRS resource set configured with a resourceType value of “aperiodic” in the higher layer signaling SRS-ResourceSet.
      One SRS resource set configured with a resourceType value of “aperiodic” in the higher layer signaling SRS-ResourceSet
      Two SRS resource sets configured with a resourceType value of “aperiodic” in the higher layer signaling SRS-ResourceSet
      With respect to the above, if one SRS resource set is configured, each SRS resource set may include two SRS resources, the two SRS resources may be transmitted at different OFDM symbol positions in the same slot, each SRS resource within the SRS resource set may include one SRS port, and the SRS ports of each SRS resource may be connected to different UE antenna ports.
         For example, the SRS resource set may include a first and a second SRS resource including one SRS port, each SRS port of the first and second SRS resources may be connected to a different UE antenna port, the SRS port of the first SRS resource may be transmitted at a first OFDM symbol position within a first slot, and the SRS port of the second SRS resource may be transmitted at a second OFDM symbol position in the same slot.
      With respect to the above, if two SRS resource sets are configured, each SRS resource within the two SRS resource sets may be transmitted at the same or different OFDM symbol positions within the two different slots, each SRS resource set may include one SRS resource, each SRS resource within the two SRS resource sets may include one SRS port, and the SRS ports of each SRS resource within the two SRS resource sets may be connected to different UE antenna ports.
         For example, a first SRS resource including one SRS port may be included in the first SRS resource set, and a second SRS resource including one SRS port may be included in the second SRS resource set, each SRS port of the first and second SRS resources may be connected to a different UE antenna port, the SRS port of the first SRS resource may be transmitted at a first OFDM symbol position in the first slot, and the SRS port of the second SRS resource may be transmitted at a second OFDM symbol position in the second slot. In this case, the first and second OFDM symbol positions may be the same or different within each slot, but the slot positions may be different from each other.
If the UE does not report both the srs-AntennaSwitching2SP-1Periodic-r17 and srs-ExtensionAperiodicSRS-r17, which are UE capability reports.
   The UE may receive, from the base station, a maximum of two SRS resource sets configured with different resourceType values in the higher layer signaling SRS-ResourceSet.
   With respect to the above, each SRS resource set may include two SRS resources, the two SRS resources may be transmitted at different OFDM symbol positions, each SRS resource within the SRS resource set may include one SRS port, and the SRS ports of each SRS resource may be connected to different UE antenna ports.
   For example, the SRS resource set may include a first and a second SRS resource including one SRS port, each SRS port of the first and second SRS resources may be connected to a different UE antenna port, the SRS port of the first SRS resource may be transmitted at a first OFDM symbol position, and the SRS port of the second SRS resource may be transmitted at a second OFDM symbol position. In this case, the first and second OFDM symbol positions are different from each other, but the slot positions may be the same or different from each other.

### [2T4R]

With respect to the 2T4R operation of the UE, the UE may receive higher layer signaling configured from the base station and perform 2T4R operation accordingly, such as a combination including at least one of the following.
In case that the UE has reported a part or all of the UE capability reports srs-AntennaSwitching2SP-1Periodic-r17 and srs-Extension AperiodicSRS-r17
   In case that the UE has reported only srs-AntennaSwitching2SP-1Periodic-r17,
      The UE may receive, from the base station, a maximum of two SRS resource sets in the higher layer signaling SRS-ResourceSet, configured with a resourceType value of “semi-persistent,” and may receive, from the base station, a maximum of one SRS resource set in the higher layer signaling SRS-ResourceSet, configured with a resourceType value of “periodic” or,
      The UE may receive, from the base station, a maximum of two SRS resource sets configured with different resourceType values in the higher layer signaling SRS-ResourceSet.
      In addition to the above, two SRS resource sets configured with a resourceType value of “semi-persistent” in the higher layer signaling SRS-ResourceSet may not be activated at the same time.
      With respect to the above, each SRS resource set may contain two SRS resources transmitted in different OFDM symbols.
      With respect to the above, each SRS resource within each SRS resource set may include two SRS ports, and the two SRS ports of each SRS resource within each SRS resource set may be connected to different UE antenna ports.
         For example, the SRS resource set may include a first and a second SRS resource including one SRS port, the two SRS ports of the first and second SRS resources may be connected to different UE antenna ports, the two SRS ports of the first SRS resource may be transmitted at a first OFDM symbol position, the two SRS ports of the second SRS resource may be transmitted at a second OFDM symbol position, and the first and second OFDM symbol positions may be different within each slot, but may have the same or different slot positions.
   In case that the UE has reported only srs-ExtensionAperiodicSRS-r17,
      The UE may receive, from the base station, a maximum of two SRS resource sets configured with a value of resourceType as “aperiodic” in the higher layer signaling SRS-ResourceSet, and may receive, from the base station, a maximum of one SRS resource set configured with a value of resourceType as “periodic” or “semi-persistent” in the higher layer signaling SRS-ResourceSet, or
      The UE may receive, from the base station, a maximum of two SRS resource sets configured with different resourceType values in the higher layer signaling SRS-ResourceSet.
      With respect to the above details, if the UE receives, from the base station, two SRS resource sets configured with a resourceType value of “aperiodic” in the higher layer signaling SRS-ResourceSet, each SRS resource in the two SRS resource sets may be transmitted at the same or different OFDM symbol positions within two different slots, each SRS resource set may include one SRS resource, each SRS resource within the two SRS resource sets may include two SRS ports, and the two SRS ports of each SRS resource within the two SRS resource sets may be connected to different UE antenna ports.
         For example, a first SRS resource including two SRS ports may be included in the first SRS resource set, a second SRS resource including two SRS ports may be included in the second SRS resource set, the two SRS ports of the first and second SRS resources may be connected to different UE antenna ports, the two SRS ports of the first SRS resource may be transmitted at the first OFDM symbol position of the first slot, and the two SRS ports of the second SRS resource may be transmitted at the second OFDM symbol position of the second slot. In this case, the first and second OFDM symbol positions may be the same or different within each slot, but the slot positions may be different from each other.
      With respect to the above, if the UE receives, from the base station, one SRS resource set configured with a resourceType value of “aperiodic” in the higher layer signaling SRS-ResourceSet, the two SRS resources in the corresponding SRS resource set may be transmitted at different OFDM symbol positions in the same slot, each SRS resource in the corresponding SRS resource set may include two SRS ports, and the SRS ports of each SRS resource may be connected to different UE antenna ports.
      With respect to the above, if the UE receives, from the base station, one SRS resource set configured with a resourceType value of “periodic” or “semi-persistent” in the higher layer signaling SRS-ResourceSet, the two SRS resources in the corresponding SRS resource set may be transmitted at different OFDM symbol positions, each SRS resource in the corresponding SRS resource set may include two SRS ports, and the two SRS ports of each SRS resource may be connected to different UE antenna ports.
         For example, the SRS resource set may include a first and a second SRS resource including two SRS ports, the two SRS ports of the first and second SRS resources may be connected to different UE antenna ports, the two SRS ports of the first SRS resource may be transmitted at a first OFDM symbol position, and the two SRS ports of the second SRS resource may transmit at a second OFDM symbol position. In this case, the first and second OFDM symbol positions may be different from each other, but the slot positions may be the same or different from each other.
   In case that the UE does not report srs-AntennaSwitching2SP-1 Periodic-r17, the UE may receive, from the base station, a maximum of two different SRS resource sets (e.g., 0, 1, or 2) configured with a resourceType value in the higher layer signaling SRS-ResourceSet, the resourceType having a value of either “periodic” or “semi-persistent.” For example, the UE may be configured with one of the following from the base station.
      The UE does not receive an SRS resource set configured with a resourceType value of “periodic” or “semi-persistent” in the higher layer signaling SRS-ResourceSet.
      One SRS resource set configured with a resourceType value of “periodic” in the higher layer signaling SRS-ResourceSet
      One SRS resource set configured with a resourceType value of “semi-persistent” in the higher layer signaling SRS-ResourceSet
      One SRS resource set configured with a resourceType value of “periodic” and one SRS resource set configured with a resourceType value of “semi-persistent” in the higher layer signaling SRS-ResourceSet.
      With respect to the above, two SRS resource sets configured with a resourceType value of “semi-persistent” in the higher layer signaling SRS-ResourceSet may not be activated at the same time.
      With respect to the above, each SRS resource set may include two SRS resources, the two SRS resources may be transmitted at different OFDM symbol positions, each SRS resource within the SRS resource set may include two SRS ports, and the two SRS ports of each SRS resource may be connected to different UE antenna ports.
         For example, the SRS resource set may include a first and a second SRS resource including two SRS ports, the two SRS ports of the first and second SRS resources may be connected to different UE antenna ports, the two SRS ports of the first SRS resource may be transmitted at a first OFDM symbol position, and the two SRS ports of the second SRS resource may be transmitted at a second OFDM symbol position. In this case, the first and second OFDM symbol positions are different from each other, but the slot positions may be the same or different from each other.
   In case that the UE has reported srs-AntennaSwitching2SP-1Periodic-r17, the UE may receive, from the base station, a maximum of two SRS resource sets configured with resourceType value of “semi-persistent” in the higher layer signaling SRS-ResourceSet, and may receive, from the base station, a maximum of one SRS resource set configured with resourceType value of “periodic” in the higher layer signaling SRS-ResourceSet.
      With respect to the above, two SRS resource sets configured with a resourceType value of “semi-persistent” in the higher layer signaling SRS-ResourceSet may not be activated at the same time.
      With respect to the above, each SRS resource set may include two SRS resources, the two SRS resources may be transmitted at different OFDM symbol positions, each SRS resource within the SRS resource set may include two SRS ports, and the two SRS ports of each SRS resource may be connected to different UE antenna ports.
         For example, the SRS resource set may include a first and a second SRS resource including two SRS ports, the two SRS ports of the first and second SRS resources may be connected to different UE antenna ports, the two SRS ports of the first SRS resource may be transmitted at a first OFDM symbol position, and the two SRS ports of the second SRS resource may be transmitted at a second OFDM symbol position. In this case, the first and second OFDM symbol positions are different from each other, but the slot positions may be the same or different from each other.
   In case that the UE does not report srs-Extension AperiodicSRS-r17, the UE may receive, from the base station, a maximum of one SRS resource set (e.g., 0 or 1) configured with a resourceType value of “aperiodic” in the higher layer signaling SRS-ResourceSet. For example, the UE may be configured with one of the following from the base station.
      The UE does not receive an SRS resource set configured with a resourceType value of “aperiodic” in the higher layer signaling SRS-ResourceSet.
      One SRS resource set configured with a resourceType value of “aperiodic” in the higher layer signaling SRS-ResourceSet
      With respect to the above, if one SRS resource set is configured, each SRS resource set may include two SRS resources, the two SRS resources may be transmitted at different OFDM symbol positions in the same slot, each SRS resource within the SRS resource set may include two SRS ports, and the two SRS ports of each SRS resource may be connected to different UE antenna ports.
         For example, the SRS resource set may include a first and a second SRS resource including two SRS ports, the two SRS ports of the first and second SRS resources may be connected to different UE antenna ports, the two SRS ports of the first SRS resource may be transmitted at a first OFDM symbol position within a first slot, and the two SRS ports of the second SRS resource may be transmitted at a second OFDM symbol position in the same slot.
   In case that the UE has reported srs-ExtensionAperiodicSRS-r17, the UE may receive, from the base station, a maximum of two SRS resource sets (e.g., 0, 1 or 2) configured with a resourceType value of “aperiodic” in the higher layer signaling SRS-ResourceSet. For example, the UE may be configured with one of the following from the base station.
      The UE does not receive an SRS resource set configured with a resourceType value of “aperiodic” in the higher layer signaling SRS-ResourceSet.
      One SRS resource set configured with a resourceType value of “aperiodic” in the higher layer signaling SRS-ResourceSet
      Two SRS resource sets configured with a resourceType value of “aperiodic” in the higher layer signaling SRS-ResourceSet
      With respect to the above, if one SRS resource set is configured, each SRS resource set may include two SRS resources, the two SRS resources may be transmitted at different OFDM symbol positions in the same slot, each SRS resource within the SRS resource set may include two SRS ports, and the two SRS ports of each SRS resource may be connected to different UE antenna ports.
         For example, the SRS resource set may include a first and a second SRS resource including two SRS ports, the two SRS ports of the first and second SRS resources may be connected to different UE antenna ports, the two SRS ports of the first SRS resource may be transmitted at a first OFDM symbol position within a first slot, and the two SRS ports of the second SRS resource may be transmitted at a second OFDM symbol position in the same slot.
      With respect to the above, if two SRS resource sets are configured, each SRS resource within the two SRS resource sets may be transmitted at the same or different OFDM symbol positions within the two different slots, each SRS resource set may include one SRS resource, each SRS resource within the two SRS resource sets may include two SRS ports, and the two SRS ports of each SRS resource within the two SRS resource sets may be connected to different UE antenna ports.
         For example, a first SRS resource including two SRS ports may be included in the first SRS resource set, and a second SRS resource including two SRS ports may be included in the second SRS resource set, the two SRS ports of the first and second SRS resources may be connected to different UE antenna ports, the two SRS ports of the first SRS resource may be transmitted at the first OFDM symbol position of the first slot, and the two SRS ports of the second SRS resource may be transmitted at the second OFDM symbol position of the second slot. In this case, the first and second OFDM symbol positions may be the same or different within each slot, but the slot positions may be different from each other.
In case that the UE does not report both UE capability reports, srs-AntennaSwitching2SP-1Periodic-r17 and srs-ExtensionAperiodicSRS-r17.
   The UE may receive, from the base station, a maximum of two SRS resource sets configured with different resourceType values in the higher layer signaling SRS-ResourceSet.
   With respect to the above, each SRS resource set may include two SRS resources, the two SRS resources may be transmitted at different OFDM symbol positions, each SRS resource within the SRS resource set may include two SRS ports, and the two SRS ports of each SRS resource may be connected to different UE antenna ports.
      For example, the SRS resource set may include a first and a second SRS resource including two SRS ports, the two SRS ports of the first and second SRS resources may be connected to different UE antenna ports, the two SRS ports of the first SRS resource may be transmitted at a first OFDM symbol position, and the two SRS ports of the second SRS resource may be transmitted at a second OFDM symbol position. In this case, the first and second OFDM symbol positions are different from each other, but the slot positions may be the same or different from each other.

### [1T4R]

With respect to the 1T4R operation of the UE, the UE may receive higher layer signaling configured from the base station and may perform the 1T4R operation accordingly, such as a combination including at least one of the following.
In case that the UE has reported a part or all of the UE capability reports srs-AntennaSwitching2SP-1Periodic-r17, srs-ExtensionAperiodicSRS-r17, and srs-OneAP-SRS-r17.
   In case that the UE does not report srs-AntennaSwitching2SP-1 Periodic-r17, the UE may receive, from the base station, a maximum of one SRS resource set (e.g., 0 or 1) configured with a resourceType value of “periodic” or “semi-persistent” in the higher layer signaling SRS-ResourceSet. For example, the UE may be configured with one of the following from the base station.
      The UE does not receive an SRS resource set configured with a resourceType value of “periodic” or “semi-persistent” in the higher layer signaling SRS-ResourceSet.
      One SRS resource set configured with a resourceType value of “periodic” in the higher layer signaling SRS-ResourceSet
      One SRS resource set configured with a resourceType value of “semi-persistent” in the higher layer signaling SRS-ResourceSet
      With respect to the above, each SRS resource set may include four SRS resources, the four SRS resources may be transmitted at different OFDM symbol positions, each SRS resource within the SRS resource set may include one SRS port, and the one SRS port of each SRS resource may be connected to different UE antenna ports.
         For example, the SRS resource set may include a first to a fourth SRS resource including one SRS port, the one SRS port of the first to fourth SRS resources may be connected to different UE antenna ports, the one SRS port of the first to fourth SRS resources may be transmitted at first to fourth OFDM symbol positions, the first to fourth OFDM symbol positions may be different from each other, but the slot positions may be the same or different from each other.
   In case that the UE has reported srs-AntennaSwitching2SP-1Periodic-r17, the UE may receive, from the base station, a maximum of two SRS resource sets configured with resourceType value of “semi-persistent” in the higher layer signaling SRS-ResourceSet, and may receive, from the base station, a maximum of one SRS resource set configured with resourceType value of “periodic” in the higher layer signaling SRS-ResourceSet.
      With respect to the above, two SRS resource sets configured with a resourceType value of “semi-persistent” in the higher layer signaling SRS-ResourceSet may not be activated at the same time.
      With respect to the above, each SRS resource set may include four SRS resources, the four SRS resources may be transmitted at different OFDM symbol positions, each SRS resource within the SRS resource set may include one SRS port, and the one SRS port of each SRS resource may be connected to different UE antenna ports.
         For example, the SRS resource set may include a first to a fourth SRS resource including one SRS port, the one SRS port of the first to fourth SRS resources may be connected to different UE antenna ports, the one SRS port of the first to fourth SRS resources may be transmitted at first to fourth OFDM symbol positions, the first to fourth OFDM symbol positions may be different from each other, but the slot positions may be the same or different from each other.
   Depending on whether the UE reports either srs-ExtensionAperiodicSRS-r17 or srs-OneAP-SRS-r17, which is the UE capability report, the following higher layer signaling configuration of the base station and operation of the UE may be expected.
      In case that the UE does not report both srs-ExtensionAperiodicSRS-r17 and srs-OneAP-SRS-r17, the UE may receive, from the base station, zero or two SRS resource sets configured with a resourceType value of “aperiodic” in the higher layer signaling SRS-ResourceSet.
      In case that the UE has reported both srs-ExtensionAperiodicSRS-r17 and srs-OneAP-SRS-r17, the UE may receive, from the base station, 0, 1, 2 or 4 SRS resource sets configured with a resourceType value of “aperiodic” in the higher layer signaling SRS-ResourceSet.
      In case that the UE has reported only srs-ExtensionAperiodicSRS-r17 between the srs-ExtensionAperiodicSRS-r17 and srs-OneAP-SRS-r17, the UE may receive, from the base station, 0, 2 or 4 SRS resource sets configured with a value of resourceType “aperiodic” in the higher layer signaling SRS-ResourceSet.
      In case that the UE has reported only srs-OneAP-SRS-r17 between the srs-ExtensionAperiodicSRS-r17 and srs-OneAP-SRS-r17, the UE may receive, from the base station, 0, 1 or 2 SRS resource sets configured with the value of resourceType “aperiodic” in the higher layer signaling SRS-ResourceSet.
      With respect to the above, if one SRS resource set is configured, each SRS resource set may include four SRS resources, the four SRS resources may be transmitted at different OFDM symbol positions in the same slot, each SRS resource within the SRS resource set may include one SRS port, and the one SRS port of each SRS resource may be connected to different UE antenna ports.
         For example, the SRS resource set may include a first to a fourth SRS resource including one SRS port, the one SRS port of the first to fourth SRS resources may be connected to different UE antenna ports, the one SRS port of the first to fourth SRS resources may be transmitted at first to fourth OFDM symbol positions in the same slot, and the first to fourth OFDM symbol positions may be different from each other.
      With respect to the above, if two SRS resource sets are configured,
         Each SRS resource set may contain two SRS resources, or the first SRS resource set may have one SRS resource, and the second SRS resource set may have three SRS resources.
         Each SRS resource within each SRS resource set may be transmitted at different OFDM symbol positions in the same slot, and the SRS transmissions for each SRS resource set may be performed in different slots. SRS transmissions between different SRS resources in different SRS resource sets may be performed at the same or different OFDM symbol positions, but the slot positions may be different.
         Each SRS resource may include one SRS port, and one SRS port of each SRS resource may be connected to different UE antenna ports.
         For example, the first SRS resource set may include a first and a second SRS resource each including one SRS port, and the second SRS resource set may include a third and a fourth SRS resource each including one SRS port. The one SRS port of the first to fourth SRS resources may be connected to different UE antenna ports. The one SRS port of each of the first and second SRS resources may be transmitted at first and second OFDM symbol positions in a predetermined same slot, and the first and second OFDM symbol positions may be different. The one SRS port of each of the third and fourth SRS resources may be transmitted at the third and fourth OFDM symbol positions in a slot different from a slot in which the first and second SRS resources have been transmitted, and the third and fourth OFDM symbol positions may be different. In this case, the first OFDM symbol position and the third and fourth OFDM symbol positions may be the same or different from each other, and similarly, the second OFDM symbol position may be the same or different from the third and fourth OFDM symbol positions.
         For example, a first SRS resource including one SRS port may be included in a first SRS resource set, and a second to a fourth SRS resource each including one SRS port may be included in a second SRS resource set. The one SRS port of the first to fourth SRS resources may be connected to different UE antenna ports. The one SRS port of the first SRS resource may be transmitted at a first OFDM symbol position in a predetermined slot. The one SRS port of each of the second to fourth SRS resources may be transmitted at a second to a fourth OFDM symbol position in a slot different from a slot in which the first SRS resource has been transmitted, and the second and fourth OFDM symbol positions may be different. In this case, the first OFDM symbol position and the second to fourth OFDM symbol positions may be the same or different from each other.
      With respect to the above, if four SRS resource sets are configured, each SRS resource set may include one SRS resource, the four SRS resources may be transmitted at the same or different OFDM symbol positions within each slot, and the SRS transmissions for each SRS resource set may be performed in different slots. Each SRS resource within the corresponding SRS resource set may include one SRS port, and the one SRS port of each SRS resource may be connected to a different UE antenna port.
         For example, the first to fourth SRS resource sets may each include a first to a fourth SRS resource (i.e., one SRS resource is included in one SRS resource set), the one SRS port of the first to fourth SRS resources may be connected to a different UE antenna port, the one SRS port of the first to fourth SRS resources may be transmitted at the first to fourth OFDM symbol positions within different slots, and the first to fourth OFDM symbol positions within each slot may be the same or different from each other, but the slot positions may be different from each other.
In case that the UE does not report all of the UE capability reports: srs-AntennaSwitching2SP-1Periodic-r17, srs-ExtensionAperiodicSRS-r17, and srs-OneAP-SRS-r17, i.e., does not report all three UE capabilities,
   The UE may receive, from the base station, a maximum of one SRS resource set (i.e., 0 or 1) configured with a value of resourceType as “periodic” or “semi-persistent” in the higher layer signaling SRS-ResourceSet.
      With respect to the above, each SRS resource set may include four SRS resources, the four SRS resources may be transmitted at different OFDM symbol positions, each SRS resource within the SRS resource set may include one SRS port, and the one SRS port of each SRS resource may be connected to different UE antenna ports.
         For example, the SRS resource set may include a first to a fourth SRS resource including one SRS port, the one SRS port of the first to fourth SRS resources may be connected to different UE antenna ports, the one SRS port of the first to fourth SRS resources may be transmitted at first to fourth OFDM symbol positions, the first to fourth OFDM symbol positions may be different from each other, but the slot positions may be the same or different from each other.
   The UE may receive, from the base station, zero or two SRS resource sets configured with the value of resourceType “aperiodic” in the higher layer signaling SRS-ResourceSet. If two SRS resource sets are configured, some or all of the following may be considered.
      Each SRS resource set may contain two SRS resources, or the first SRS resource set may have one SRS resource, and the second SRS resource set may have three SRS resources.
      Each SRS resource within each SRS resource set may be transmitted at different OFDM symbol positions in the same slot, the SRS transmissions for each SRS resource set may be performed in different slots. SRS transmissions between different SRS resources in different SRS resource sets may be performed at the same or different OFDM symbol positions, but slot positions may be different.
      Each SRS resource may include one SRS port, and one SRS port of each SRS resource may be connected to different UE antenna ports.
      For example, the first SRS resource set may include a first and a second SRS resource each including one SRS port, and the second SRS resource set may include a third and a fourth SRS resource each including one SRS port. The one SRS port of the first to fourth SRS resources may be connected to different UE antenna ports. The one SRS port of each of the first and second SRS resources may be transmitted at first and second OFDM symbol positions in a predetermined same slot, and the first and second OFDM symbol positions may be different. The one SRS port of each of the third and fourth SRS resources may be transmitted at the third and fourth OFDM symbol positions in a slot different from the slot in which the first and second SRS resources have been transmitted, and the third and fourth OFDM symbol positions may be different. In this case, the first OFDM symbol position and the third and fourth OFDM symbol positions may be the same or different from each other, and similarly, the second OFDM symbol position may be the same or different from the third and fourth OFDM symbol positions.
      For example, a first SRS resource including one SRS port may be included in a first SRS resource set, and a second to a fourth SRS resource each including one SRS port may be included in a second SRS resource set. The one SRS port of the first to fourth SRS resources may be connected to different UE antenna ports. The one SRS port of the first SRS resource may be transmitted at a first OFDM symbol position in a predetermined slot. One SRS port of each of the second to fourth SRS resource may be transmitted at a second to a fourth OFDM symbol position in a slot different from the slot in which the first SRS resource has been transmitted, and the second and fourth OFDM symbol positions may be different. In this case, the first OFDM symbol position and the second to fourth OFDM symbol positions may be the same or different from each other.
In addition to the above, if multiple SRS resource sets are configured (for example, two or four SRS resource sets)
   The UE may expect that each of the power control parameters p0, alpha, pathlossReferenceRS, srs-PowerControlAdjustmentStates, which may be configured by higher layer signaling within each SRS resource set from the base station, is configured to have the same value in all SRS resource sets. In other words, the UE may expect that all multiple SRS resource sets have the same power control parameters. These constraints may be described later as [Power Control Parameter Constraints].
      The above [Power control parameter constraints] may only be applied to SRS resource sets in which the UE has received, from the base station, a resourceType value configured as “aperiodic” in the higher layer signaling SRS-ResourceSet.
      The above [Power control parameter constraints] may be applied to SRS resource sets in which the UE has received, from the base station, a resourceType value configured as “periodic,” “semi-persistent,” or “aperiodic” in the higher layer signaling SRS-ResourceSet.
   The UE may expect from the base station that the value of the higher layer signaling aperiodicSRS-ResourceTrigger or the value of one entry in the higher layer signaling AperiodicSRS-ResourceTriggerList is configured to have the same value for all SRS resource sets. These constraints may be described later as [Aperiodic SRS Trigger Constraints].
      In case that the higher layer signaling aperiodicSRS-ResourceTrigger, which is configured in the SRS resource set from the base station, refers to aperiodic SRS trigger state information, and if the UE receives a non-periodic SRS trigger for a specific non-periodic SRS trigger state from the base station through DCI and a value configured in the higher layer signaling aperiodicSRS-Resource Trigger is the aperiodic SRS trigger state indicated by the corresponding DCI, the UE may perform aperiodic SRS transmission for the corresponding SRS resource set.
      Similarly, in case that the higher layer signaling AperiodicSRS-ResourceTriggerList, which is configured within the SRS resource set from the base station, contains multiple pieces of aperiodic SRS trigger state information, and if the UE receives the aperiodic SRS trigger for a specific aperiodic SRS trigger state from the base station through DCI and multiple values configured in the higher layer signaling AperiodicSRS-ResourceTriggerList include the aperiodic SRS trigger state indicated by the DCI, the UE may perform aperiodic SRS transmission for the corresponding SRS resource set.
      While the higher layer signaling aperiodicSRS-ResourceTrigger provides a function for an SRS resource set to be included in a single aperiodic SRS trigger state, the higher layer signaling AperiodicSRS-ResourceTriggerList may provide a function for the SRS resource set to be included in multiple aperiodic SRS trigger states, and this may increase the likelihood of the SRS resource set being triggered by the base station.
      The above [Aperiodic SRS trigger constraints] may only be applied to SRS resource sets in which the UE has received, from the base station, a resourceType value configured as “aperiodic” in the higher layer signaling SRS-ResourceSet.
   The UE may expect that the base station has different values for the higher layer signaling slotOffset within each SRS resource set. These constraints may be described later as [Slot offset considerations].
      The above [Slot offset considerations] may only be applied to SRS resource sets in which the UE has received, from the base station, a resourceType value configured as “aperiodic” in the higher layer signaling SRS-ResourceSet.

### [1T1R, 2T2R, and 4T4R]

With respect to the 1T1R, 2T2R, and 4T4R operations of the UE, the UE may receive higher layer signaling configured from the base station, such as a combination including at least one of the following, and may perform the 1T1R, 2T2R, and 4T4R operations accordingly.
In case that the UE does not report the UE capability report srs-AntennaSwitching2SP-1Periodic-r17, the UE may receive a maximum of two SRS resource sets configured from the base station.
In case that the UE has reported the UE capability report srs-AntennaSwitching2SP-1Periodic-r17, the UE may receive the following higher layer signaling configuration from the base station.
   Two SRS resource sets with a resourceType value of “semi-persistent” in the higher layer signaling SRS-ResourceSet, and one SRS resource set with a resourceType value of “periodic” in the higher layer signaling SRS-ResourceSet
      With respect to the above, two SRS resource sets configured with a resourceType value of “semi-persistent” in the higher layer signaling SRS-ResourceSet may not be activated at the same time.

### Maximum of Two SRS Resource Sets

Each SRS resource set contains one SRS resource, and in case of 1T1R, 2T2R, and 4T4R, the number of SRS ports configured in each SRS resource may be one, two, and four, respectively.
In case of 1T1R, 2T2R, and 4T4R, the UE may not expect that SRS transmissions for two or more SRS resource sets having usage which is higher layer signaling configured as “antennaSwitching” are configured or triggered at the same OFDM symbol position.

### [1T6R]

With respect to the 1T6R operation of the UE, the UE may receive higher layer signaling configured from the base station, such as a combination including at least one of the following, and may perform the 1T6R operation accordingly.
The UE may receive, from the base station, a maximum of one (i.e., 0 or 1) SRS resource set configured with a resourceType value of “periodic” in the higher layer signaling SRS-ResourceSet, one SRS resource set may contain six SRS resources, each SRS resource may include one SRS port, each SRS resource may be transmitted at different OFDM symbol positions in the same or different slots, and one SRS port of each SRS resource may be connected to different UE antenna ports.
The UE may receive, from the base station, a configuration for an SRS resource set having a resourceType value of “semi-persistent” in the higher layer signaling SRS-ResourceSet, as shown in the following example.
   In case that the UE does not report the UE capability report srs-AntennaSwitching2SP-1Periodic-r17, the UE may receive, from the base station, a maximum of one SRS resource set (i.e., 0 or 1) configured with a resourceType value of “semi-persistent” in the higher layer signaling SRS-ResourceSet.
   In case that the UE has reported the UE capability report srs-AntennaSwitching2SP-1Periodic-r17, the UE may receive, from the base station, a maximum of two (i.e., 0, 1, or 2) SRS resource sets configured with a resourceType value of “semi-persistent” in the higher layer signaling SRS-ResourceSet, and the two SRS resource sets with a resourceType value of “semi-persistent” in the higher layer signaling SRS-ResourceSet may not be activated at the same time.
   One SRS resource set may include six SRS resources, each SRS resource may include one SRS port, each SRS resource may be transmitted at different OFDM symbol positions in the same or different slots, and one SRS port of each SRS resource may be connected to different UE antenna ports.
The UE may receive, from the base station, a maximum of three SRS resource sets (i.e., 0, 1, 2, or 3) configured with a resourceType value of “aperiodic” in the higher layer signaling SRS-ResourceSet.
   In case that one SRS resource set is configured, 6 SRS resources may be included therein, each SRS resource may include 1 SRS port, each SRS resource may be transmitted at different OFDM symbol positions in the same slot, and 1 SRS port of each SRS resource may be connected to different UE antenna ports.
   In case that two SRS resource sets are configured, a total of six SRS resources may be divided and included in the two SRS resource sets, each SRS resource may include one SRS port, all SRS resources within each SRS resource set may be transmitted at different OFDM symbol positions in the same slot, SRS transmissions for different SRS resource sets may be performed at the same or different OFDM symbol positions in different slots, and one SRS port of each SRS resource may be connected to different UE antenna ports.
      For example, the UE may include a first to a third SRS resource in the first SRS resource set, and a fourth to a sixth SRS resource in the second SRS resource set. The transmission for the first to third SRS resources in the first SRS resource set may be performed at the first to third OFDM symbol positions in the first slot, and the first to third OFDM symbol positions may be different from each other. The transmission for the fourth to sixth SRS resources in the second SRS resource set may be performed at the fourth to sixth OFDM symbol positions in the second slot, and the fourth to sixth OFDM symbol positions may be different from each other. In this case, the first and second slot positions may be different from each other, and the first to third OFDM symbol positions and the fourth to sixth OFDM symbol positions may be the same or different from each other.
      For example, it may be possible for the first and second SRS resource sets to include one SRS resource (e.g., the first SRS resource) and five SRS resources (e.g., the second to sixth SRS resources), respectively, and other combinations may not be excluded.
   In case that three SRS resource sets are configured, a total of six SRS resources may be divided and included in the three SRS resource sets, each SRS resource may include one SRS port, all SRS resources within each SRS resource set may be transmitted at different OFDM symbol positions in the same slot, SRS transmissions for different SRS resource sets may be performed at the same or different OFDM symbol positions in different slots, and one SRS port of each SRS resource may be connected to different UE antenna ports.
      For example, the UE may include a first and a second SRS resource in the first SRS resource set, include a third and a fourth SRS resource in the second SRS resource set, and include a fifth and a sixth SRS resource in the third SRS resource set. Transmission for the first and second SRS resources in the first SRS resource set may be performed at the first and second OFDM symbol positions in a first slot, and the first and second OFDM symbol positions may be different from each other. Transmission for the third and fourth SRS resources within the second SRS resource set may be performed at the third and fourth OFDM symbol positions in a second slot, and the third and fourth OFDM symbol positions may be different from each other. The transmission for the fifth and sixth SRS resources within the third SRS resource set may be performed at the fifth and sixth OFDM symbol positions in a third slot, and the fifth and sixth OFDM symbol positions may be different from each other. In this case, the first, second, and third slot positions may be different from each other, and the first and second OFDM symbol positions, the third and fourth OFDM symbol positions, and the fifth and sixth OFDM symbol positions may be the same or different from each other.
      For example, it is possible for the first, second, and third SRS resource sets to include three SRS resources (e.g., the first to third SRS resources), two SRS resources (e.g., the fourth and fifth SRS resources), and one SRS resource (e.g., the sixth SRS resource), respectively, and other combinations may not be excluded.

### [1T8R]

With respect to the 1T8R operation of the UE, the UE may receive higher layer signaling configured from the base station, such as a combination including at least one of the following, and may perform the 1T8R operation accordingly.
The UE may receive, from the base station, a maximum of one (i.e., 0 or 1) SRS resource set configured with a resourceType value of “periodic” in the higher layer signaling SRS-ResourceSet, one SRS resource set may contain eight SRS resources, each SRS resource may include one SRS port, each SRS resource may be transmitted at different OFDM symbol positions in the same or different slots, and one SRS port of each SRS resource may be connected to different UE antenna ports.
The UE may receive, from the base station, a configuration for an SRS resource set having a resourceType value of “semi-persistent” in the higher layer signaling SRS-ResourceSet, as shown in the following example.
   In case that the UE does not report the UE capability report srs-AntennaSwitching2SP-1Periodic-r17, the UE may receive, from the base station, a maximum of one SRS resource set (i.e., 0 or 1) configured with a resourceType value of “semi-persistent” in the higher layer signaling SRS-ResourceSet.
   In case that the UE has reported the UE capability report srs-AntennaSwitching2SP-1Periodic-r17, the UE may receive, from the base station, a maximum of two (i.e., 0, 1, or 2) SRS resource sets having a resourceType value of “semi-persistent” in the higher layer signaling SRS-ResourceSet, and the two SRS resource sets having a resourceType value of “semi-persistent” in the higher layer signaling SRS-ResourceSet may not be activated at the same time.
   One SRS resource set may include eight SRS resources, each SRS resource may include one SRS port, each SRS resource may be transmitted at different OFDM symbol positions in the same or different slots, and one SRS port of each SRS resource may be connected to different UE antenna ports.
The UE may receive, from the base station, 0, 2, 3, or 4 SRS resource sets configured with a resourceType value of “aperiodic” in the higher layer signaling SRS-ResourceSet.
   In case that two SRS resource sets are configured, a total of eight SRS resources may be divided and included in the two SRS resource sets, each SRS resource may include one SRS port, all SRS resources within each SRS resource set may be transmitted at different OFDM symbol positions in the same slot, SRS transmissions for different SRS resource sets may be performed at the same or different OFDM symbol positions in different slots, and one SRS port of each SRS resource may be connected to different UE antenna ports.
      For example, the UE may include a first to a fourth SRS resource in the first SRS resource set, and a fifth to an eighth SRS resource in the second SRS resource set. The transmission for the first to fourth SRS resources in the first SRS resource set may be performed at the first to fourth OFDM symbol positions in the first slot, and the first to fourth OFDM symbol positions may be different from each other. The transmission for the fifth to eighth SRS resources in the second SRS resource set may be performed at the fifth to eighth OFDM symbol positions in the second slot, and the fifth to eighth OFDM symbol positions may be different from each other. In this case, the first and second slot positions may be different from each other, and the first to fourth OFDM symbol positions and the fifth to eighth OFDM symbol positions may be the same or different from each other.
      For example, it may be possible for the first and second SRS resource sets to include one SRS resource (e.g., the first SRS resource) and seven SRS resources (e.g., the second to eighth SRS resources), respectively, and other combinations may not be excluded.
   In case that three SRS resource sets are configured, a total of eight SRS resources may be divided and included in the three SRS resource sets, each SRS resource may include one SRS port, all SRS resources within each SRS resource set may be transmitted at different OFDM symbol positions in the same slot, SRS transmissions for different SRS resource sets may be performed at the same or different OFDM symbol positions in different slots, and one SRS port of each SRS resource may be connected to different UE antenna ports.
      For example, the UE may include a first to third SRS resource in the first SRS resource set, a fourth to a sixth SRS resource in the second SRS resource set, and a seventh and an eighth SRS resource in the third SRS resource set. The transmission for the first to third SRS resources in the first SRS resource set may be performed at the first to third OFDM symbol positions in the first slot, and the first to third OFDM symbol positions may be different from each other. Transmission of the fourth to sixth SRS resources within the second SRS resource set may be performed at the fourth to sixth OFDM symbol positions in the second slot, and the fourth to sixth OFDM symbol positions may be different. The transmission for the seventh and eighth SRS resources in the third SRS resource set may be performed at the seventh and eighth OFDM symbol positions in the third slot, and the seventh and eighth OFDM symbol positions may be different from each other. In this case, the first, second, and third slot positions may be different from each other, and the first to third OFDM symbol positions, the fourth to sixth OFDM symbol positions, and the seventh and eighth OFDM symbol positions may be the same or different from each other.
      For example, it is possible for the first, second, and third SRS resource sets to include four SRS resources (e.g., the first to fourth SRS resources), two SRS resources (e.g., the fifth and sixth SRS resources), and two SRS resources (e.g., the seventh and eighth SRS resources), respectively, and other combinations may not be excluded.
   In case that four SRS resource sets are configured, a total of eight SRS resources may be divided and included in the four SRS resource sets, each SRS resource may include one SRS port, all SRS resources within each SRS resource set may be transmitted at different OFDM symbol positions in the same slot, SRS transmissions for different SRS resource sets may be performed at the same or different OFDM symbol positions in different slots, and one SRS port of each SRS resource may be connected to different UE antenna ports.
      For example, the UE may include a first and a second SRS resource in the first SRS resource set, include a third and a fourth SRS resource in the second SRS resource set, include a fifth and a sixth SRS resource in the third SRS resource set, and include a seventh and an eighth SRS resource in the fourth SRS resource set. Transmission for the first and second SRS resources in the first SRS resource set may be performed at the first and second OFDM symbol positions in the first slot, and the first and second OFDM symbol positions may be different from each other. Transmission for the third and fourth SRS resources within the second SRS resource set may be performed at the third and fourth OFDM symbol positions in the second slot, and the third and fourth OFDM symbol positions may be different. Transmission for the 5th and 6th SRS resources within the third SRS resource set may be performed at the 5th and 6th OFDM symbol positions in the third slot, and the 5th and 6th OFDM symbol positions may be different. Transmission for the 7th and 8th SRS resources in the 4th SRS resource set may be performed at the 7th and 8th OFDM symbol positions in the 4th slot, and the 7th and 8th OFDM symbol positions may be different from each other. In this case, the first to fourth slot positions may be different from each other, and the first and second OFDM symbol positions, the third and fourth OFDM symbol positions, the fifth and sixth OFDM symbol positions, and the seventh and eighth OFDM symbol positions may be the same or different from each other.
      For example, it may be possible for the first, second, third, and fourth SRS resource sets to include three SRS resources (e.g., the first to third SRS resources), two SRS resources (e.g., the fourth and fifth SRS resources), two SRS resources (e.g., the sixth and seventh SRS resources), and one SRS resource (e.g., the eighth SRS resource), respectively, and other combinations may not be excluded.

### [2T6R]

With respect to the 2T6R operation of the UE, the UE may receive higher layer signaling configured from the base station, such as a combination including at least one of the following, and may perform the 2T6R operation accordingly.
The UE may receive, from the base station, a maximum of one (i.e., 0 or 1) SRS resource set configured with a resourceType value of “periodic” in the higher layer signaling SRS-ResourceSet, one SRS resource set may include three SRS resources. Further, each SRS resource may include two SRS ports, and each SRS resource may be transmitted at different OFDM symbol positions in the same or different slots. Further, the two SRS ports of each SRS resource may be connected to different UE antenna ports.
The UE may receive, from the base station, a configuration for an SRS resource set having a resourceType value of “semi-persistent” in the higher layer signaling SRS-ResourceSet, as shown in the following example.
   In case that the UE does not report the UE capability report srs-AntennaSwitching2SP-1Periodic-r17, the UE may receive, from the base station, a maximum of one SRS resource set (i.e., 0 or 1) configured with a resourceType value of “semi-persistent” in the higher layer signaling SRS-ResourceSet.
   In case that the UE has reported the UE capability report srs-AntennaSwitching2SP-1Periodic-r17, the UE may receive, from the base station, a maximum of two (i.e., 0, 1, or 2) SRS resource sets configured with a resourceType value of “semi-persistent” in the higher layer signaling SRS-ResourceSet, and the two SRS resource sets having a resourceType value of “semi-persistent” in the higher layer signaling SRS-ResourceSet may not be activated at the same time.
   One SRS resource set may include three SRS resources, each SRS resource may include two SRS ports, each SRS resource may be transmitted at different OFDM symbol positions in the same or different slots, and the two SRS ports of each SRS resource may be connected to different UE antenna ports.
The UE may receive, from the base station, a maximum of three SRS resource sets (i.e., 0, 1, 2, or 3) configured with a resourceType value of “aperiodic” in the higher layer signaling SRS-ResourceSet.
   In case that one SRS resource set is configured, 3 SRS resources may be included therein, each SRS resource may include 2 SRS ports, each SRS resource may be transmitted at different OFDM symbol positions in the same slot, and the 2 SRS ports of each SRS resource may be connected to different UE antenna ports.
   In case that two SRS resource sets are configured, a total of three SRS resources may be divided and included in the two SRS resource sets, and each SRS resource may include two SRS ports. Further, all SRS resources within each SRS resource set may be transmitted at different OFDM symbol positions in the same slot, and SRS transmissions for different SRS resource sets may be performed at the same or different OFDM symbol positions in different slots. In addition, the two SRS ports of each SRS resource may be connected to different UE antenna ports.
      For example, the UE may include a first and a second SRS resource in the first SRS resource set, and include a third SRS resource in the second SRS resource set. Transmission for the first and second SRS resources in the first SRS resource set may be performed at first and second OFDM symbol positions in the first slot, and the first and second OFDM symbol positions may be different. Transmission for the third SRS resource in the second SRS resource set may be performed at the third OFDM symbol position in the second slot. In this case, the first and second slot positions may be different from each other, and the first and second OFDM symbol positions and the third OFDM symbol position may be the same or different from each other.
      For example, it may be possible for the first and second SRS resource sets to include one SRS resource (e.g., the first SRS resource) and two SRS resources (e.g., the second and third SRS resources), respectively, and other combinations may not be excluded.
   In case that three SRS resource sets are configured, a total of three SRS resources may be divided and included in the three SRS resource sets, and each SRS resource may include two SRS ports. Further, all SRS resources within each SRS resource set may be transmitted at different OFDM symbol positions in the same slot, and SRS transmissions for different SRS resource sets may be performed at the same or different OFDM symbol positions in different slots. In addition, the two SRS ports of each SRS resource may be connected to different UE antenna ports.
      For example, the UE may include a first SRS resource in the first SRS resource set, a second SRS resource in the second SRS resource set, and a third SRS resource in the third SRS resource set. Transmission for the first SRS resource within the first SRS resource set may be performed at the first OFDM symbol position in the first slot. Transmission for the second SRS resource within the second SRS resource set may be performed at the second OFDM symbol position in the second slot. Transmission for the third SRS resource in the third SRS resource set may be performed at the third OFDM symbol position in the third slot. In this case, the first, second, and third slot positions may be different from each other, and the first to third OFDM symbol positions may be the same or different from each other.

### [2T8R]

With respect to the 2T8R operation of the UE, the UE may receive higher layer signaling configured from the base station, such as a combination including at least one of the following, and may perform the 2T8R operation accordingly.
The UE may receive, from the base station, a maximum of one (i.e., 0 or 1) SRS resource set configured with a resourceType value of “periodic” in the higher layer signaling SRS-ResourceSet. Further, one SRS resource set may include four SRS resources, each SRS resource may include two SRS ports, and each SRS resource may be transmitted at different OFDM symbol locations in the same or different slots. Further, the two SRS ports of each SRS resource may be connected to different UE antenna ports.
The UE may receive, from the base station, a configuration for an SRS resource set having a resourceType value of “semi-persistent” in the higher layer signaling SRS-ResourceSet, as shown in the following example.
   In case that the UE does not report the UE capability report srs-AntennaSwitching2SP-1Periodic-r17, the UE may receive, from the base station, a maximum of one SRS resource set (i.e., 0 or 1) configured with a resourceType value of “semi-persistent” in the higher layer signaling SRS-ResourceSet.
   In case that the UE has reported the UE capability report srs-AntennaSwitching2SP-1Periodic-r17, the UE may receive, from the base station, a maximum of two (i.e., 0, 1, or 2) SRS resource sets having a resourceType value of “semi-persistent” in the higher layer signaling SRS-ResourceSet, and the two SRS resource sets having a resourceType value of “semi-persistent” in the higher layer signaling SRS-ResourceSet may not be activated at the same time.
   One SRS resource set may include four SRS resources, each SRS resource may include two SRS ports, each SRS resource may be transmitted at different OFDM symbol positions in the same or different slots, and the two SRS ports of each SRS resource may be connected to different UE antenna ports.
The UE may receive 0, 2, 3, or 4 SRS resource sets configured with a resourceType value of “aperiodic” in the higher layer signaling SRS-ResourceSet from the base station.
   In case that one SRS resource set is configured, four SRS resources may be included therein, each SRS resource may include two SRS ports, each SRS resource may be transmitted at different OFDM symbol positions in the same slot, and the two SRS ports of each SRS resource may be connected to different UE antenna ports.
   In case that two SRS resource sets are configured, a total of four SRS resources may be divided and included in the two SRS resource sets, each SRS resource may include two SRS ports, all SRS resources within each SRS resource set may be transmitted at different OFDM symbol positions in the same slot, SRS transmissions for different SRS resource sets may be performed at the same or different OFDM symbol positions in different slots, and the two SRS ports of each SRS resource may be connected to different UE antenna ports.
      For example, the UE may include a first and a second SRS resource in the first SRS resource set and include a third and a fourth SRS resource in the second SRS resource set. Transmission for the first and second SRS resources in the first SRS resource set may be performed at first and second OFDM symbol positions in the first slot, and the first and second OFDM symbol positions may be different. Transmission for the third and fourth SRS resources in the second SRS resource set may be performed at the third and fourth OFDM symbol positions in the second slot, and the third and fourth OFDM symbol positions may be different from each other. In this case, the first and second slot positions may be different from each other, and the first and second OFDM symbol positions and the third and fourth OFDM symbol positions may be the same or different from each other.
      For example, it may be possible for the first and second SRS resource sets to include one SRS resource (e.g., the first SRS resource) and three SRS resources (e.g., the second to fourth SRS resources), respectively, and other combinations may not be excluded.
   In case that three SRS resource sets are configured, a total of four SRS resources may be divided and included in the three SRS resource sets, each SRS resource may include two SRS ports. Further, all SRS resources within each SRS resource set may be transmitted at different OFDM symbol positions in the same slot, and SRS transmissions for different SRS resource sets may be performed at the same or different OFDM symbol positions in different slots. Further, the two SRS ports of each SRS resource may be connected to different UE antenna ports.
      For example, the UE may include a first and a second SRS resource in the first SRS resource set, include a third SRS resource in the second SRS resource set, and include a fourth SRS resource in the third SRS resource set. Transmission for the first and second SRS resources in the first SRS resource set may be performed at the first and second OFDM symbol positions in the first slot, and the first and second OFDM symbol positions may be different from each other. Transmission for the third SRS resource within the second SRS resource set may be performed at the third OFDM symbol position in the second slot. Transmission for the fourth SRS resource in the third SRS resource set may be performed at the fourth OFDM symbol position in the third slot. In this case, the first, second, and third slot positions may be different from each other, and the first to fourth OFDM symbol positions may be the same or different from each other.
      For example, it is possible for the first, second, and third SRS resource sets to include one SRS resource (e.g., the first SRS resource), two SRS resources (e.g., the second and third SRS resources), and one SRS resource (e.g., the fourth SRS resource), respectively, and other combinations may not be excluded.
   In case that four SRS resource sets are configured, a total of four SRS resources may be divided and included in the four SRS resource sets, each SRS resource may include two SRS ports. Further, all SRS resources within each SRS resource set may be transmitted at different OFDM symbol positions in the same slot, and SRS transmissions for different SRS resource sets may be performed at the same or different OFDM symbol positions in different slots. Further, the two SRS ports of each SRS resource may be connected to different UE antenna ports.
      For example, the UE may include a first, second, third, and fourth SRS resource in the first, second, third, and fourth SRS resource set, respectively, the transmission for the first, second, third, and fourth SRS resources in the first, second, third, and fourth SRS resource sets may be performed at first, second, third, and fourth OFDM symbol positions in the first, second, third, and fourth slots, respectively, the first to fourth slot positions may be different from each other, and the first to fourth OFDM symbol positions may be the same or different from each other.

### [4T8R]

With respect to the 4T8R operation of the UE, the UE may receive higher layer signaling configured from the base station, such as a combination including at least one of the following, and may perform the 4T8R operation accordingly.
If the UE does not report the UE capability report srs-AntennaSwitching2SP-1 Periodic-r17,
   The UE may receive, from the base station, a maximum of two different SRS resource sets (e.g., 0, 1, or 2) configured with a resourceType value of “periodic” or “semi-persistent” in the higher layer signaling SRS-ResourceSet. For example, the UE may be configured with one of the following from the base station.
      The UE does not receive an SRS resource set configured with a resourceType value of “periodic” or “semi-persistent” in the higher layer signaling SRS-ResourceSet.
      One SRS resource set configured with a resourceType value of “periodic” in the higher layer signaling SRS-ResourceSet
      One SRS resource set configured with a resourceType value of “semi-persistent” in the higher layer signaling SRS-ResourceSet
      In the higher layer signaling SRS-ResourceSet, there is one SRS resource set with a resourceType value of “periodic” and one SRS resource set with a resourceType value of “semi-persistent.”
      With respect to the above, each SRS resource set may include two SRS resources, and each SRS resource may include four SRS ports. Each SRS resource may be transmitted at different OFDM symbol positions in the same or different slots, and the four SRS ports of each SRS resource may be connected to different UE antenna ports.
In case that the UE has reported the UE capability report srs-AntennaSwitching2SP-1Periodic-r17, the UE may receive, from the base station, a maximum of two (i.e., 0, 1, or 2) SRS resource sets configured with a resourceType value of “semi-persistent” in the higher layer signaling SRS-ResourceSet, a maximum of one (i.e., 0 or 1) SRS resource set configured with a resourceType value of “periodic” in the higher layer signaling SRS-ResourceSet, and two SRS resource sets with a resourceType value of “semi-persistent” in the higher layer signaling SRS-ResourceSet may not be activated at the same time.
   Each SRS resource set may include two SRS resources, each SRS resource may include four SRS ports, each SRS resource may be transmitted at different OFDM symbol positions in the same or different slots, and the four SRS ports of each SRS resource may be connected to different UE antenna ports.
The UE may receive 0, 1, or 2 SRS resource sets having a resourceType value of “aperiodic” in the higher layer signaling SRS-ResourceSet from the base station.
   In case that one SRS resource set is configured, two SRS resources may be included therein, each SRS resource may include four SRS ports, each SRS resource may be transmitted at different OFDM symbol positions in the same slot, and the four SRS ports of each SRS resource may be connected to different UE antenna ports.
   In case that two SRS resource sets are configured, a total of two SRS resources may be divided and included in the two SRS resource sets, and each SRS resource may include four SRS ports. Further, all SRS resources within each SRS resource set may be transmitted at different OFDM symbol positions in the same slot, and SRS transmissions for different SRS resource sets may be performed at the same or different OFDM symbol positions in different slots. In addition, the four SRS ports of each SRS resource may be connected to different UE antenna ports.
      For example, the UE may include first and second SRS resources in the first and second SRS resource sets, respectively, and the transmission for the first and second SRS resources in the first and second SRS resource sets may be performed at first and second OFDM symbol positions in the first and second slots, respectively. In this case, the first and second slot positions may be different from each other, and the first and second OFDM symbol positions may be the same or different from each other.

In case that the UE performs an antenna switching operation, i.e., if the UE transmits different SRS resources connected to different antenna port(s), the time interval between two adjacent SRS resources among all transmitted SRS resources is generally required to be about 15 μs. Taking this into consideration, a (minimum) guard period may be defined as shown in [Table 13] below.

TABLE 13

| μ | Δf = 2^{μ} · 15 [KHz] | Y [symbol] |
|---|---|---|
| 0 | 15 | 1 |
| 1 | 30 | 1 |
| 2 | 60 | 1 |
| 3 | 120 | 2 |

In Table 13, u may denote a numerology, Δf may denote a subcarrier spacing, and Y may denote the number of OFDM symbols representing a guard period, i.e., the time length of the guard period. Referring to Table 13, the guard period may be configured based on a parameter u that determines the numerology. During the guard period, the UE is configured not to transmit any other signals, and the guard period may be configured to be used entirely for antenna switching.

For example, the guard period may be established between the transmission times of two adjacent SRS resources, by considering SRS resources transmitted at different OFDM symbol positions in the same slot.

For example, in case that the UE has received two SRS resource sets configured of antenna switching usage, and the corresponding two SRS resource sets are configured or triggered to be transmitted in two consecutive slots, and the UE has reported a UE capability capable of transmitting SRS at all OFDM symbol positions in a slot, the UE may expect that there is a guard period for antenna switching at least as many as Y OFDM symbols, based on [Table 13] above, between the last OFDM symbol in which SRS transmission is performed within a first slot in which SRS transmission is performed for a first SRS resource set and the first OFDM symbol in which SRS transmission is performed within a second slot in which SRS transmission is performed for a second SRS resource set. In other words, the actual time difference between two SRS transmissions may be greater than or equal to Y OFDM symbols.
For such an inter-slot guard period, similar to the guard period between two SRS resources in the same slot described above, the UE may not transmit any signal during the period of Y OFDM symbols in case that the actual time difference between the last SRS transmission in the first slot and the first SRS transmission in the next slot within two consecutive slots is Y OFDM symbols.
For such an inter-slot guard period, in case that the actual time difference between the last SRS transmission of the first slot and the first SRS transmission of the next slot within two consecutive slots is Y OFDM symbols, if the SRS transmissions before and after the inter-slot guard period are all dropped (all canceled) due to overlap with other signals, the UE may determine that the inter-slot guard period defined by Y OFDM symbols has been dropped (canceled) by applying the same priority as the SRS transmissions before and after the guard period. In addition, when the UE determines that all SRS transmissions before and after the inter-slot guard period have been dropped (all canceled), the UE may perform uplink transmissions in this inter-slot guard period.

For all antenna switching schemes described above, the UE may expect that all SRS resources in all SRS resource sets within the SRS resource set having usage which is higher layer signaling configured as “antennaSwitching” are configured with the same number of SRS ports from the base station.

For antenna switching schemes based on the 1T2R, 1T4R, 2T4R, 1T6R, 1T8R, 2T6R, 2T8R, and 4T8R operations described above, the UE may not expect that two or more SRS resource sets having usage which is higher layer signaling configured as “antennaSwitching” are configured or triggered in the same slot from the base station.

For antenna switching schemes based on the 1T1R, 2T2R, and 4T4R operations described above, the UE may not expect that two or more SRS resource sets having usage which is higher layer signaling configured as “antennaSwitching” are configured or triggered in the same OFDM symbol from the base station.

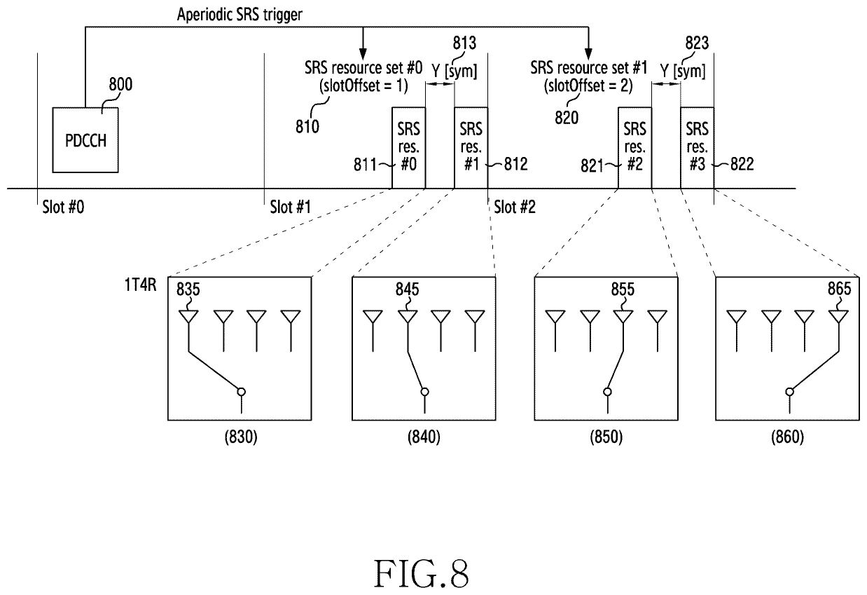

FIG. 8 illustrates an example of an SRS antenna switching operation according to an embodiment of the present disclosure.

The UE is in a situation operating in 1T4R, which may be a situation in which two aperiodic SRS resource sets (e.g., SRS resource sets #0 and #1) are configured. The UE may receive a PDCCH from a base station (indicated by reference numeral 800) and may be instructed to trigger an aperiodic SRS for SRS resource set #0 810 and SRS resource set #1 820 via the PDCCH. In this case, a slot offset value for SRS resource set #0 810 may be configured with the higher layer signaling slotOffset, which has a value of 1, and an aperiodic SRS transmission for SRS resource set #0 may be performed at a position 1 slot later (i.e., at slot #1) from a slot in which the PDCCH has been received. Additionally, a slot offset value for SRS resource set #1 820 may be configured with the higher layer signaling slotOffset, which has a value of 2, and an aperiodic SRS transmission for SRS resource set #1 may be performed at a position 2 slots later from the slot in which the PDCCH has been received (i.e., in slot #2).

SRS resource #0 811 and SRS resource #1 812 included in SRS resource set #0 810 are transmitted at different OFDM symbol locations within slot #1, and Y OFDM symbols may exist as a guard period between SRS resources #0 and #1 (indicated by reference numeral 813). Further, when transmitting SRS resource #0 (indicated by reference numeral 830), the UE may perform SRS transmission by connecting one SRS port to a first reception antenna port 835 of the UE, and when transmitting to SRS resource #1 (indicated by reference numeral 840), the UE may perform SRS transmission by connecting one SRS port to a second reception antenna port 845 of the UE.

SRS resource #2 821 and SRS resource #3 822 included in SRS resource set #1 820 are transmitted at different OFDM symbol locations within slot #1, Y OFDM symbols may exist as a guard period between SRS resources #2 and #3 (indicated by reference numeral 823). Further, when transmitting to SRS resource #2 (indicated by reference numeral 850), the UE may perform SRS transmission by connecting one SRS port to a third reception antenna port 855 of the UE, and when transmitting to SRS resource #3 (indicated by reference numeral 860), the UE may perform SRS transmission by connecting one SRS port to a fourth reception antenna port 865 of the UE.

By connecting the four SRS resources #0 to #3 described above to the different reception antenna ports of the UE and transmitting the SRS, the UE may transmit the SRS from all different reception antenna ports so that the base station may obtain channel information connected to all reception antennas of the UE, whereby the base station can obtain channel information between the base station and the UE to use the acquired information for uplink or downlink scheduling.

### [SRS: Carrier Switching]

Next, SRS carrier switching is described. In the TDD system, SRS carrier switching is used to perform SRS transmission to support downlink channel estimation of a base station with respect to a support cell in which PUSCH/PUCCH transmission is not configured, i.e., a cell supporting only downlink transmission. This is because channel reciprocity is established between a downlink and an uplink channel in the TDD system, and the base station may estimate a downlink channel based on an uplink channel estimated through the SRS. The estimating of the downlink channel through the SRS-based channel reciprocity has the advantage of requiring a smaller overhead compared to the estimating of the CSI-RS-based downlink channel in case that the base station performs a support using a large number of antennas but the UE performs a support using a relatively small number of antennas.

In order to transmit the SRS to a cell supporting only downlink transmission through SRS carrier switching, the UE may use an RF transmitter for uplink transmission of one cell among other cells. This is because a target cell for performing SRS carrier switching (hereinafter referred to as a target cell or target component carrier (CC)) is in a frequency band for supporting only downlink transmission in which PUCCH/PUSCH transmission is not configured, and therefore, the UE does not use the RF transmitter except for the SRS carrier switching usage. Therefore, when considering aspects such as the cost of the UE, there is no separate arrangement of an RF transmitter for uplink transmission to a target cell for performing SRS carrier switching, and when SRS carrier switching is scheduled (hereinafter, scheduling for performing SRS carrier switching may include both aperiodic (AP) triggering based on downlink control information (DCI) format 2_3 and scheduling based on semi-persistent (SP) or periodic (P) triggering based on higher layer signaling configuration), the UE may transmit the SRS by retuning an RF transmitter for uplink transmission of another cell. A cell in which the RF transmitter is arranged before the UE performs retuning in order to perform the SRS carrier switching may be defined as a source cell (hereinafter referred to as a source cell or source CC), which may be configured in the UE through the UE's higher layer parameters srs-SwitchFromServCellIndex and srs-SwitchFromCarrier. The higher layer parameter srs-SwitchFromServCellIndex indicates a cell index of the source CC, and srs-SwitchFromCarrier indicates one of the NUL and SUL of the target CC to determine the RF transmitter that the UE is required to retune.

When performing SRS carrier switching, the UE requires a retuning time, which is a time taken by the RF transmitter of the source CC to prepare to transmit the SRS to the target CC, and a time to retune the RF transmitter back to the source CC after transmitting all SRSs to the target CC. This is a time additionally required in addition to the preparation time required to transmit an SRS for the usage other than SRS carrier switching. The UE may, with regard to a retuning time of the RF transmitter required before and after performing SRS carrier switching, report the UE capability to the base station and notify the base station of the required time. Here, the UE may report the retuning time of the RF transmitter to the base station through switchingTimeUL and switchingTimeDL.

Since the UE performs retuning of the RF transmitter from the source CC in order to perform SRS carrier switching, the UE is unable to transmit an uplink signal (e.g., PUCCH, PUSCH, or SRS) to the source CC while transmitting SRS to the target CC. Therefore, in order to perform SRS carrier switching, the UE first identifies whether the uplink transmission scheduled for the source CC and the SRS transmission including the RF retuning time overlap. If the uplink transmission scheduled for the source CC and the SRS transmission scheduled for the target CC (including a retuning time) overlap, and the simultaneous transmission (behind the UE's indicated UL CA capability) is not possible, the UE may compare the priorities between the two signals and transmit only one uplink signal. In this case, the priority for SRS carrier switching defined in NR release 15/16 is as follows.
If a PUSCH or PUCCH including one or multiple pieces of information of HARQ-ACK/positive scheduling request (SR)/rank indicator (RI)/CSI-RS resource indicator (CRI)/SS/PBCH block resource indicator (SSBRI) and/or a physical random access channel (PRACH) in the source CC overlap with the SRS transmission to the target CC, the UE may not perform the SRS transmission of the target CC. In other words, the UE may transmit the scheduled uplink signal in the source CC without performing SRS carrier switching.
If the PUSCH including aperiodic CSI in the source CC overlaps with the periodic or semi-persistent SRS transmission in the target CC, the UE may not perform the periodic or semi-persistent SRS transmission of the target CC. In other words, the UE may transmit the scheduled uplink signal in the source CC without performing SRS carrier switching.
If the PUCCH or PUSCH including periodic or semi-persistent CSI configured by one or multiple pieces of information of only channel quality indicator (CQI)/precoding matrix indicator (PMI)/layer 1 reference signal received power (L1-RSRP)/layer 1 signal to interference plus noise ratio (L1-SINR) and/or SRS in the source CC overlaps with the SRS transmission in the target CC, the UE may not perform the PUCCH or PUSCH and/or SRS transmission of the source CC. That is, the UE may perform the SRS transmission to the target CC by performing SRS carrier switching.
If the PUSCH including aperiodic CSI configured by one or multiple pieces of information of only CQI/PMI/L1-RSRP/L1-SINR in the source CC overlaps with aperiodic SRS transmission in the target CC, the UE may not perform the PUSCH transmission of the source CC. In other words, the UE may transmit the aperiodic SRS to the target CC by performing SRS carrier switching.

When comparing a priority between the uplink transmission of the source CC and the SRS transmission of the target CC described above, the UE may consider a time to receive and decode the DCI for scheduling each transmission, a time to determine the uplink transmission according to the higher layer signaling configuration, a preparation time required to perform uplink signal transmission, and an SRS transmission preparation time to which the RF retuning time of the target CC is added. This is because once the UE prepares for either the uplink transmission of the source CC or the SRS transmission of the target CC, cancellation is not possible. For example, even when the DCI for scheduling uplink signal transmission having a higher priority to the source CC is received while the UE is preparing for the SRS transmission to the pre-scheduled target CC (considering all the preparation times, such as DCI decoding and RF retuning time), the UE may not cancel the SRS transmission to the target CC. Since this case is classified as a scheduling error case, the base station may consider the following conditions when performing SRS carrier switching. In order to cancel one of the specific transmissions (uplink signal transmission in the source CC or SRS transmission in the target CC), the UE starts SRS transmission in symbol N_{c}_{₁} of carrier c₁ (target CC) and applies the priority rule described above (a priority rules between the uplink transmission of the source CC and the SRS transmission of the target CC) with regard to conflicting uplink transmissions in symbol N_{C}_{₁} of carrier c₂ (source CC), by considering the following conditions.
DCI(s) may be received by the UE so that an interval between the last symbol of the PDCCH and N_{C}_{₁} is at least greater than a value obtained by adding the symbol N₂ and T_{DRS}_{_{CN}}, and an interval between the last symbol of the PDCCH and N_{C}_{₂} is at least greater than the symbol N₂. In this case, the DCI may correspond to both DCI for scheduling the uplink signal transmission in the source CC and DCI for scheduling the SRS transmission in the target CC.
Semi-persistent CSI reporting or SRS transmissions may be activated before an interval at least greater than a value obtained by adding the symbol N₂ and T_{SRS}_{_{CS}} based on N_{C}_{₁}, and may be activated before an interval at least greater than the symbol N_{C} based on N_{C}_{₂}. The activated transmission may include both the uplink transmission in the source CC and the SRS transmission in the target CC.

Here, T_{SRS}_{_{CS}} corresponds to T_{SRS}_{_{CS}}=max{switchingTimeUL, switchingTimeDL} and the time interval unit of the OFDM symbol is determined based on the smallest subcarrier spacing (SCS) among c₁, c₂, and the corresponding scheduling cell (if the overlapping uplink signal is not transmitted to the target CC or source CC). N₂ refers to the processing capability according to the UE capability for the PUSCH preparation process time to be described later.

When the UE receives an SRS request through DCI (or grant) for the target CC c and transmits the nth aperiodic SRS, the UE may start SRS transmission to the configured symbol and slot satisfying the following conditions.
The configured symbol and slot correspond to a value later than the total sum of the detailed conditions below.
   The maximum time interval among as many time intervals as the number of N OFDM symbols for a cell including the Target CC c and DCI (or grant), respectively.
   Uplink or downlink RF retuning time defined by switchingTimeUL and switchingTimeDL of the higher layer parameter SRS-SwitchingTimeNR.
There is no conflict with any previous SRS transmission (SRS transmission before the nth aperiodic SRS), and there is no interruption due to uplink or downlink RF retuning time.

When the above condition is not satisfied, the UE does not perform transmission of the nth SRS. Here, N refers to the minimum time interval in symbol units between the DCI for triggering the aperiodic SRS and an aperiodic SRS, and corresponds to a value reported as UE capability.

In case of inter-band carrier aggregation (CA), the UE may, based on the UE capability, simultaneously transmit the SRS and PUCCH/PUSCH with respect to component carriers (CCs) of different bands.

In case of inter-band carrier aggregation (CA), the UE may, based on the UE capability, simultaneously transmit PRACH and SRS with respect to component carriers (CCs) of different bands.

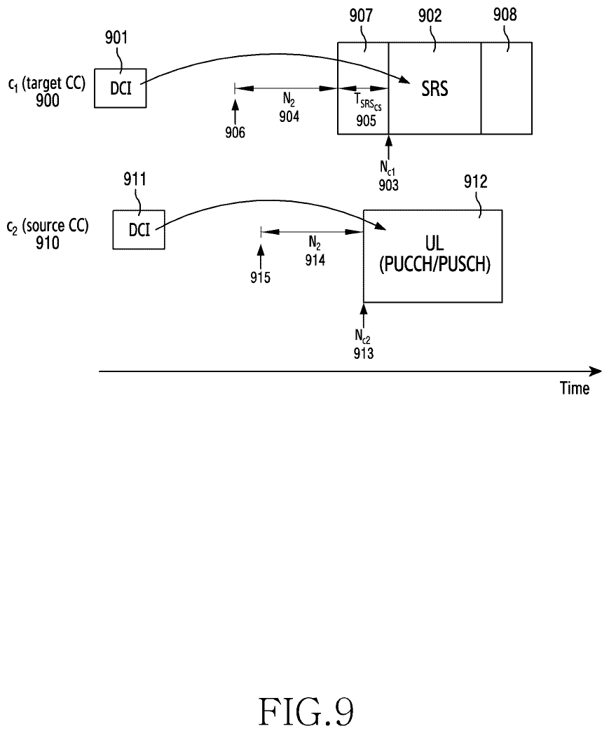

FIG. 9 illustrates an example of SRS carrier switching according to an embodiment of the present disclosure.

In FIG. 9, DCI 901 received from a target CC 900 may schedule an SRS transmission 902 through SRS carrier switching. DCI 911 received from a source CC 910 may schedule an uplink transmission 912 that may overlap with the SRS transmission 902. In this case, based on the SRS transmission start symbol N_{C}_{₁} 903, two DCIs may be received at least before the value obtained by adding the symbol N₂ 904 and T_{SRS}_{_{CN}} 905 (indicated by reference numeral 906). Additionally, based on the uplink transmission start symbol N_{C}_{₁} 913 in the source CC, two DCIs may be received at least before the symbol N₂ 914 (indicated by reference numeral 915).

In FIG. 9, reference numeral 907 denotes a time required for RF retuning from downlink to uplink in order to perform SRS carrier switching, and reference numeral 908 denotes a time required for RF retuning from uplink to downlink after SRS carrier switching is performed.

### [Regarding UE Capability Report]

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE configures UE capability according to band information and RAT type requested by the base station. The method in which the UE configures UE capability in an NR system is summarized below.
1) If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. In addition, the priority of bands follows the order described in FreqBandList.
2) If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.
3) The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step may be applied in MR-DC as well, that is, LTE bands may also be applied. BCs remaining after the above step constitute the final “candidate BC list.”
4) The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr->eutra-nr->eutra).→(nr->eutra-nr->eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs and may be acquired from feature set combinations of containers of UE-NR-Capabilities and UE-MRDC-Capabilities.
5) If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

Hereinafter, embodiments of the disclosure will be described in detail in conjunction with the accompanying drawings. The contents of the disclosure may be applied to FDD and TDD systems. As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling,” “PDCP signaling,” or “MAC control element (MAC CE).”

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, in actual applications, a TRP, a beam, or a TCI state may be appropriately replaced with one of the above terms. A beam in the disclosure may be understood as an SSB beam, a CSI-RS beam, an SSB resource, or a CSI-RS resource.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, embodiments of the disclosure will be described in detail in conjunction with the accompanying drawings. Hereinafter, a base station refers to an entity that allocates resources to a terminal, and may be at least one of a gNode B, a gNB, an eNode B, a node B, a base station (BS), a radio access unit, a base station controller, or a node on a network. A terminal may include a user equipment (UE), a mobile station (MS), a cellular phone, a smartphone, a computer, or a multimedia system capable of performing a communication function. In the following description, embodiments of the disclosure will be described in connection with 5G systems by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through multiple embodiments, but they are not independent of each other, and one or more embodiments may be applied simultaneously or in combination.

### First Embodiment: A TCI Determination Method for SRS Transmission

In an embodiment of the disclosure, a method for determining a TCI state in which a UE performs SRS transmission is described. Based on the TCI state for SRS transmission, the UE may determine a transmission beam for SRS to be transmitted (a spatial filter for transmission) and SRS transmission power. This embodiment may be operated in combination with other embodiments.

The unified TCI state-based framework described above explains the case in which one joint TCI state (or, in the case of separate TCI states, one DL TCI state and/or UL TCI state) is activated through the MAC CE and indicated through the MAC CE or DCI to be utilized for transmitting and receiving uplink and downlink channels (e.g., PDCCH/PDSCH/PUCCH/PUSCH). As an extension of this, the number of TCI states (joint TCI state or, in the case of separate TCI states, DL TCI state and/or UL TCI state) activated through the MAC CE and indicated by the MAC CE or DCI may be greater than 1 (e.g., 2). In other words, the unified TCI framework extension may define the operation of the enhanced base station and enhanced UE to utilize multiple TCI states for transmitting and receiving uplink and downlink channels (e.g., PDCCH/PDSCH/PUCCH/PUSCH). As such, when the base station and UE support the unified TCI framework extension, they may support single TRP (hereinafter, sTRP) uplink and downlink transmission and reception as well as multi-TRP (hereinafter, mTRP) uplink and downlink transmission and reception.

If the base station and UE support the unified TCI framework extension, the base station may configure RRC parameters such that periodic and/or semi-persistent and/or aperiodic SRS resource sets in which the usage of the SRS is configured as “codebook” (to indicate an SRS resource set used to support codebook-based PUSCH transmission), “nonCodebook” (to indicate an SRS resource set used to support non-codebook-based PUSCH transmission), or “antennaSwitching” (to indicate an SRS resource set to support antenna switching used for downlink channel acquisition), or an aperiodic SRS resource set in which the usage of the SRS is configured as “beamManagement” (to indicate an SRS resource set to support beam management) follows a unified TCI state (the SRS resource sets of various purposes and various time-domain behaviors described below are briefly explained as SRS resource sets in the first embodiment and the embodiments described below).

A new RRC parameter configured in an SRS resource set transmitted according to the unified TCI framework extension may be defined as “applyIndicatedTCI-State” (or may be a predetermined named RRC parameter performing the same function), and the corresponding RRC parameter may have a value configured as “first” or “second.” If the RRC parameter “apply IndicatedTCI-State” of the corresponding SRS resource set is configured as “first,” the UE may transmit all SRS resources in the corresponding SRS resource set according to the first TCI state among the multiple (e.g., two) TCI states indicated by the MAC CE or DCI. If the RRC parameter “applyIndicatedTCI-State” of the SRS resource set is configured as “second,” the UE may transmit all SRS resources in the SRS resource set according to the second TCI state among the multiple (e.g., two) TCI states indicated by the MAC CE or DCI. The first or second TCI state may be notified to the UE by the base station through the element field of the enhanced MAC CE for activating the TCI state. In other words, the UE may receive the MAC CE for activating the TCI state to identify that multiple TCI states may be activated and indicated and may distinguish between the first TCI state and the second TCI state of the multiple TCI states and use them to transmit the SRS resources in the SRS resource set.

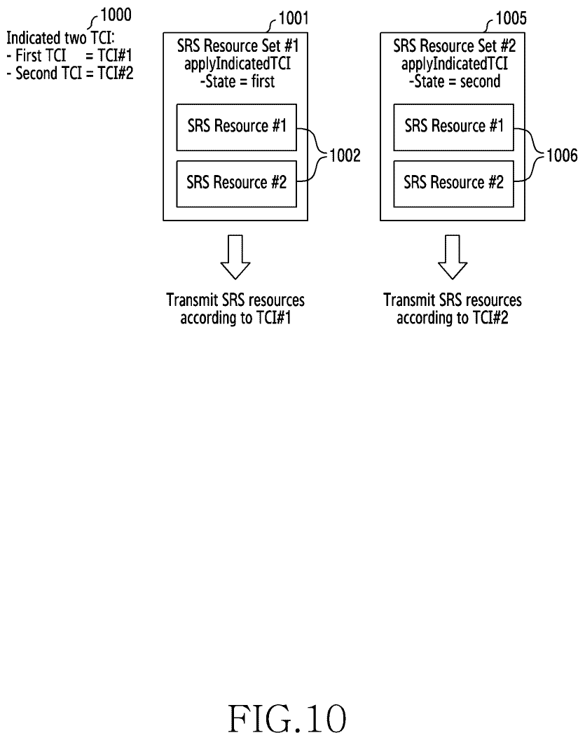

FIG. 10 illustrates an example of transmitting an SRS resource within an SRS resource set with an RRC parameter based on a unified TCI framework extension according to an embodiment of the present disclosure.

Referring to FIG. 10, a base station may configure two SRS resource sets 1001 and 1005 in a UE supporting the unified TCI framework extension. The base station may configure the RRC parameter “applyIndicatedTCI-State” in the SRS-ResourceSet configuration for the first SRS resource set 1001 as “first.” When transmitting the first SRS resource set 1001, the UE transmits all SRS resources 1002 included in the SRS resource set 1001 according to the first TCI state, TCI #1. The base station may configure the RRC parameter “applyIndicatedTCI-State” in the SRS-ResourceSet configuration for the second SRS resource set 1005 as “second.” When transmitting the second SRS resource set 1005, the UE transmits all SRS resources 1006 included in the SRS resource set 1005 according to the second TCI state, TCI #2.

If the base station and the UE support single DCI (sDCI) mTRP operation based on the unified TCI framework extension, and the new RRC parameter (e.g., “applyIndicatedTCI-State”) for determining the TCI state within the SRS resource set described above is not configured in the SRS resource set, the UE determines the uplink beam for transmitting the SRS resources in the SRS resource set, based on the RRC parameter (e.g., srs-TCI-State) configured for each SRS resource, and determines the SRS transmission power for transmitting the SRS resources in the SRS resource set, based on the RRC parameter (e.g., srs-TCI-State) configured for the SRS resource having the lowest SRS-ResourceId in the SRS resource set.

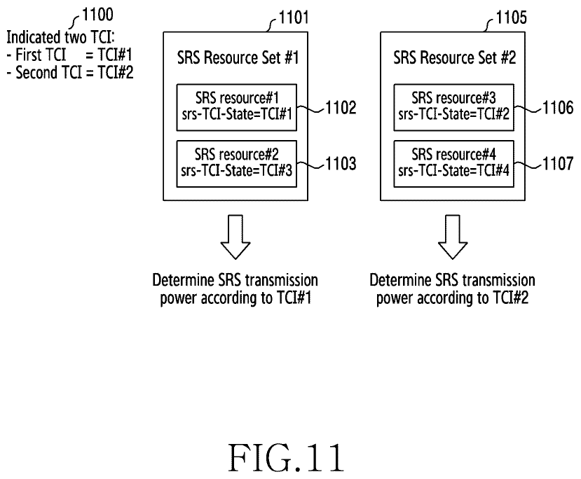

FIG. 11 illustrates an example of transmitting an SRS resource within an SRS resource set with no RRC parameters when supporting sDCI mTRP based on the unified TCI framework extension according to an embodiment of the present disclosure.

Referring to FIG. 11, a base station may configure two SRS resource sets 1101 and 1105 in a UE supporting the unified TCI framework extension. The base station may not configure the RRC parameter “applyIndicatedTCI-State” in the SRS-ResourceSet configuration for the first SRS resource set 1101. The base station may configure multiple SRS resources 1102 and 1103 in the first SRS resource set 1101 and may configure the srs-TCI-State in the SRS-ResourceSet configuration for each SRS resource. For example, the base station may configure TCI #1 as the srs-TCI-State of the first SRS resource 1102 in the first SRS resource set 1101 (expressed as TCI #1 for ease of explanation, but a TCI-StateId or TCI-Ul-StateId may be configured to accurately refer to TCI #1 and may be equally understood in the operations described later), and may configure TCI #3 as the srs-TCI-State of the second SRS resource 1103.

Here, the UE may calculate and determine the SRS transmission power for transmitting the two SRS resources 1102 and 1103 included in the first SRS resource set 1101, based on the TCI #1 configured in the first SRS resource 1102 having the lowest SRS-ResourceId in the SRS resource set (assuming that x is the SRS-ResourceId in SRS resource #x). That is, the UE may transmit the first SRS resource 1102 in the first SRS resource set 1101 by using the SRS transmission power determined according to TCI #1 and the transmission beam determined according to TCI #1 and may transmit the second SRS resource 1103 by using the SRS power determined according to TCI #1 and the transmission beam determined according to TCI #3. The UE may calculate and determine the SRS transmission power for transmitting two SRS resources 1106 and 1107 included in the second SRS resource set 1105, based on the TCI #2 configured in the first SRS resource 1106 having the lowest SRS-ResourceId in the SRS resource set (assuming that x is the SRS-ResourceId in SRS resource #x). That is, the UE may transmit the first SRS resource 1106 in the second SRS resource set 1105 by using the SRS transmission power determined according to TCI #2 and the transmission beam determined according to TCI #2 and may transmit the second SRS resource 1107 by using the SRS power determined according to TCI #2 and the transmission beam determined according to TCI #4.

If the base station and UE support multi DCI (mDCI) mTRP operation based on the unified TCI framework extension, a new RRC parameter (e.g., “applyIndicatedTCI-State”) for determining the TCI state within the SRS resource set described above has not been configured in the corresponding SRS resource set, and the time-domain behavior of that SRS resource set is aperiodic, the UE may transmit SRS resources in the SRS resource set by using the joint TCI state or UL TCI state indicated by the coresetPoolIndex value associated with the CORESET in which a PDCCH that has triggered the SRS resource set is received. Here, the TCI state (joint or UL) indicated by the coresetPoolIndex value refers to the TCI state indicated by the PDCCH received on the CORESET associated with each coresetPoolIndex value, and the TCI state may be divided into the TCI indicated by the DCI in the PDCCH received on the CORESET with coresetPoolIndex value 0 and the TCI indicated by the DCI in the PDCCH received on the CORESET with coresetPoolIndex value 1. In other words, if an SRS resource set with no applyIndicatedTCI-State configured in SRS-ResourceSet is scheduled with the PDCCH received on a CORESET with a coresetPoolIndex value of 0, the UE transmits the SRS resources in the corresponding SRS resource set according to the TCI indicated by the DCI in the PDCCH received on a CORESET with a coresetPoolIndex value of 0. If an SRS resource set with no applyIndicatedTCI-State configured in SRS-ResourceSet is scheduled with the PDCCH received on a CORESET with a coresetPoolIndex value of 1, the UE transmits the SRS resources in the corresponding SRS resource set according to the TCI indicated by the DCI in the PDCCH received on a CORESET with a coresetPoolIndex value of 1.

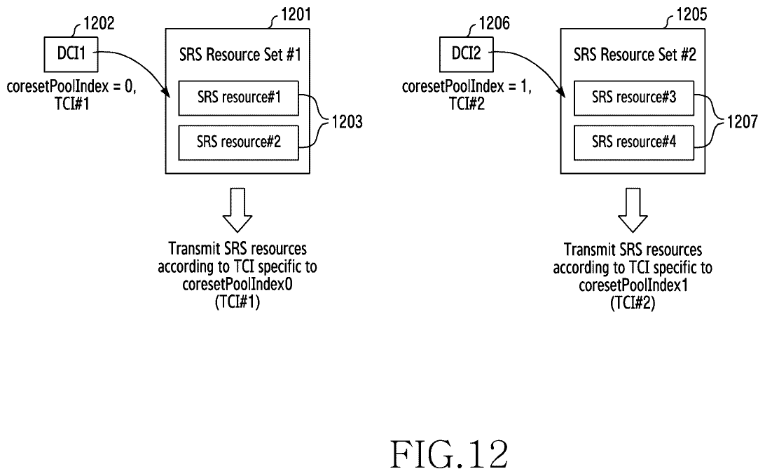

FIG. 12 illustrates an example of transmitting an SRS resource within an aperiodic SRS resource set with no RRC parameters when supporting mDCI mTRP based on the unified TCI framework extension according to an embodiment of the present disclosure.

Referring to FIG. 12, the base station may configure two SRS resource sets 1201 and 1205 on a UE supporting the unified TCI framework extension. The base station may not configure the RRC parameter “applyIndicatedTCI-State” in the SRS-ResourceSet configuration for the first SRS resource set 1201 and the second SRS resource set 1205. The base station may trigger the SRS resource sets 1201 and 1205 using DCIs 1202 and 1206. In this case, if the RRC parameter for determining the TCI for the triggered SRS resource set is not configured, the UE may transmit the SRS resources in the SRS resource set according to the TCI, which may be determined by the coresetPoolIndex associated with the CORESET in which a PDCCH containing the DCI that has triggered the SRS resource set is received.

For example, if the first DCI 1202 contained in the PDCCH received via a CORESET with a coresetPoolIndex value of 0 triggers the first SRS resource set 1201, the UE may transmit all SRS resources 1203 in the triggered SRS resource set 1201 according to a TCI state that may be determined by a coresetPoolIndex value of 0. In this case, since the TCI state determined by the coresetPoolIndex value of 0 is assumed as TCI #1, the UE may apply TCI #1 to transmit the SRS resources 1203 in the SRS resource set 1201.

For example, if the second DCI 1206 included in the PDCCH received via a CORESET with a coresetPoolIndex value of 1 triggers the second SRS resource set 1205, the UE may transmit all SRS resources 1207 in the triggered SRS resource set 1205 according to a TCI state that may be determined by a coresetPoolIndex value of 1. In this case, since the TCI state determined by the coresetPoolIndex value of 1 is assumed to be TCI #2, the UE may apply TCI #2 to transmit the SRS resources 1207 in the SRS resource set 1205.

The TCI state applied to transmit an SRS resource in the SRS resource set described in the first embodiment may be indicated through DCI according to the unified TCI framework, and may include a state that satisfies the conditions after a beam application time (BAT) from a time point at which a PUCCH including ACK is transmitted. In other words, the TCI states provided in this detailed description may be indicated through DCI at a predetermined time point in the past, and correspond to a case in which a BAT or more has elapsed since the PUCCH corresponding to the PDCCH including the DCI indicating the corresponding TCI state has been transmitted, wherein the corresponding TCI state may be applied to perform SRS transmission.

### Second Embodiment: A Configuration Method for Transmission of SRS of Antenna Switching Usage, Based on Multiple SRS Resource Sets

An embodiment of the disclosure describes a method in which a base station configures an RRC parameter to transmit an SRS of antenna switching usage including multiple SRS resource sets, and a UE transmits the multiple SRS resource sets based on the configured RRC parameter. This embodiment may be operated in combination with other embodiments.

As previously described for SRS antenna switching, the base station may receive, from the UE, supportable antenna switching candidates via UE capability. Based on this, according to an antenna switching configuration (xTyR, where x denotes the number of transmission antennas and may be any one of 1, 2, or 4, and y denotes the number of reception antennas and may be any one of 2, 4, 6, or 8, and a combination of x and y values may be defined by the values described in the antenna switching above) that the base station wants to support, and according to the time-domain behavior of the SRS resource set, there may be one or more SRS resource sets having usage “antennaSwitching” and each SRS resource set may include one or more SRS resources.

The SRS resource set for antenna switching usage is used to switch the transmission antenna of the UE to reception antennas of each UE so that the base station estimates a downlink channel based on the reciprocity of an uplink channel between all of reception antennas of the UE and the base station. With regard to antenna switching, the base station may make a configuration such that only one SRS resource set is used for switching of all the reception antennas of the UE or multiple SRS resource sets are used for the antenna switching for multiple divided different slots. In particular, the base station may make such a configuration that aperiodically transmitted multiple different SRS resource sets are transmitted through different antenna ports, in different slots, and via different symbols.

For example, if the UE performs aperiodic 1T8R-based antenna switching using four SRS resource sets, eight SRS resources are divided and included in four SRS resource sets, each SRS resource may include one SRS port, all SRS resources within each SRS resource set may be transmitted at different OFDM symbol locations in the same slot, SRS transmissions for different SRS resource sets may be performed at the same or different OFDM symbol locations in different slots, and the one SRS port of each SRS resource may be connected to different UE antenna ports.

As such, in case that the UE performs antenna switching using multiple aperiodic SRS resource sets, the UE may expect that the same transmission power parameter is configured or instructed for all the multiple SRS resource sets. In this case, the transmission power parameter may include all or some of alpha and/or p0 and/or pathlosReferenceRS and/or srs-PowerControlAdjustmentStates. Since the uplink channel for the UE to estimate the downlink channel is received by the base station through multiple SRSs, the UE may transmit the SRS resources included in the multiple SRS resource sets at the same transmission power. If the UE transmits the SRS resources in the multiple SRS resource sets with different transmission powers, the channel estimation is performed based on SRSs transmitted with unequal power rather than based on SRSs transmitted with equal power, making it difficult to accurately identify the channel quality between the base station and the reception antennas of the UE. Therefore, a rule may be established to allow the UE to transmit the multiple SRS resource sets with the same SRS transmission power even when switching antennas including the multiple SRS resource sets.

If the unified TCI framework extension is supported by the base station and the UE, the UE selects a rule to determine the TCI state to apply to the SRS to be transmitted, based on whether or not the RRC parameter for determining the TCI state to apply within the SRS resource set is configured, and whether or not the UE supports sDCI-based mTRP or mDCI-based mTRP, as described above in the first embodiment. When the UE selects the TCI of the SRS to be transmitted, based on the various situations described in the first embodiment, the UE may be scheduled to apply different TCI states for multiple SRS resource sets.

As described in FIG. 10, in case that the RRC parameter apply IndicatedTCI-State configured in the SRS resource set is configured to have different values, the UE may apply different TCI states to each SRS resource set and transmit them.

In case that the srs-TCI-State configured in the SRS resource having the lowest SRS-ResourceId within each SRS resource set has different values, as described in FIG. 11, the UE may apply a different TCI state to each SRS resource set to determine the SRS transmission power.

As illustrated in FIG. 12, in case that CORESETs associated with each PDCCH that has received DCI for scheduling each SRS resource set are associated with different coresetPoolIndex values, the UE may apply a different TCI state to each SRS resource set and transmit them.

If the base station and the UE support the unified TCI framework, since the UE determines the transmission power of the uplink channel or uplink reference signal based on the TCI state, the UE may transmit SRS resource sets to which different TCIs are applied at different transmission powers.

As described in FIGS. 10 to 12, depending on the RRC parameters and scheduling method configured by the base station, multiple SRS resource sets may be applied with different TCI states and transmitted using different transmission powers and uplink beams.

If the UE supports antenna switching using multiple aperiodic SRS resource sets, and the UE applies different TCI states to each SRS resource set and transmits the same as described in FIGS. 10 to 12, a problem may occur that the UE cannot transmit the SRS of antenna switching usage at the same SRS transmission power. Therefore, in case that the UE supports antenna switching using the multiple aperiodic SRS resource sets based on the unified TCI framework extension, the following methods may be defined to enable the UE to transmit multiple SRS resource sets of antenna switching usage at the same SRS transmission power. In order for the UE to transmit the SRS antenna switching based on the multiple SRS resource sets at the same transmission power, the UE may use one of the plurality of methods described below individually or may use at least one of the plurality of methods in combination.

### [Method 1]

The base station may configure an RRC parameter (e.g., applyIndicatedTCI-State) to indicate a TCI state to be applied to an SRS resource set for all SRS resource sets for antenna switching or may not configure the RRC parameter. In this case, the base station may configure RRC parameters for all SRS resource sets for antenna switching with respect to all time-domain behaviors (e.g., aperiodic/semi-persistent/periodic) or may not configure the RRC parameters. Alternatively, the base station may configure RRC parameters for all SRS resource sets which are for antenna switching and are configured as some time-domain behaviors or may not configure the RRC parameters. For example, the base station may or may not configure RRC parameters for all SRS resource sets which are for antenna switching and are configured as “aperiodic” (meaning the usage of the SRS resource set is configured as “antennaSwitching”).

The UE may expect that the RRC parameter to indicate the TCI state to be applied to the SRS resource set is configured or not for all SRS resource sets for antenna switching. Similarly, the UE may expect that RRC parameters are configured or not for all SRS resource sets for antenna switching with respect to all time-domain behaviors. Alternatively, the UE may expect that the RRC parameter is configured or not for all SRS resource sets which are for antenna switching and configured as some time-domain behaviors (e.g., aperiodic).

### [Method 2]

If the base station configures an RRC parameter (e.g., applyIndicatedTCI-State) to indicate a TCI state for all SRS resource sets of antenna switching usage according to an example of [Method 1], the base station may configure all the RRC parameters to have the same value in the UE. If the base station configures RRC parameters for all SRS resource sets for antenna switching with respect to all time-domain behaviors (e.g., aperiodic/semi-persistent/periodic), the base station may configure RRC parameters having the same value for all SRS resource sets for antenna switching with respect to all time-domain behaviors in the UE. Alternatively, if the base station configures RRC parameters for all SRS resource sets for antenna switching with respect to all time-domain behaviors, the base station may configure RRC parameters having the same value for all SRS resource sets for antenna switching with respect to some time-domain behaviors (e.g., aperiodic) in the UE. Alternatively, if the base station configures RRC parameters in all SRS resource sets for antenna switching with respect to some time-domain behaviors (e.g., aperiodic), the base station may configure RRC parameters having the same value for all SRS resource sets for antenna switching with respect to some time-domain behaviors (e.g., aperiodic) in the UE.

If the base station configures the RRC parameter to indicate the TCI state for all SRS resource sets, the UE may expect that RRC parameters having the same value are configured for all SRS resource sets for antenna switching. If the base station configures the RRC parameter to indicate the TCI state for all SRS resource sets, the UE may expect that RRC parameters having the same value are configured for all SRS resource sets for antenna switching with respect to all time-domain behaviors. Alternatively, if the base station configures the RRC parameter to indicate the TCI state for all SRS resource sets, the UE may expect that RRC parameters having the same value are configured for all SRS resource sets for antenna switching with respect to some time-domain behaviors (e.g., aperiodic).

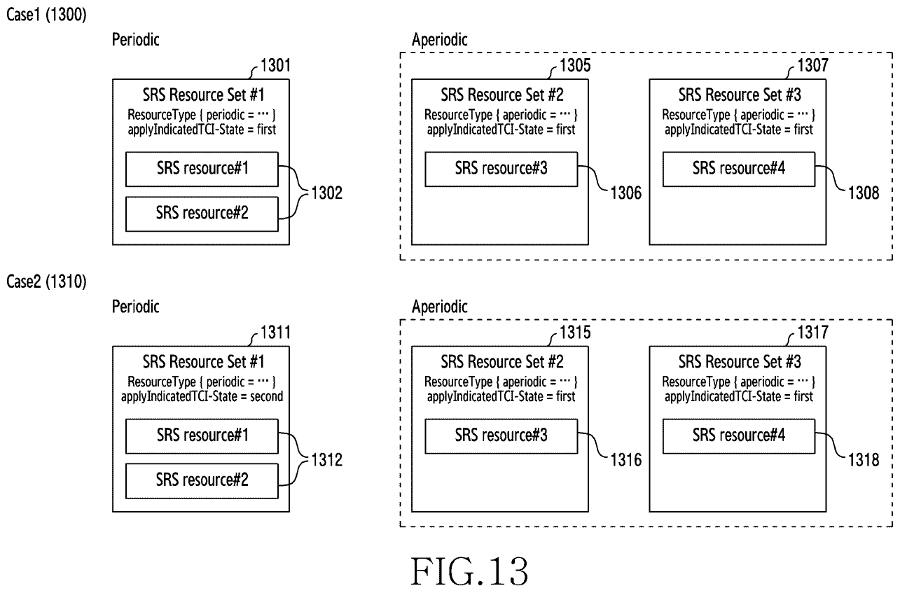

FIG. 13 illustrates an example of an SRS resource set according to an embodiment of the present disclosure. Specifically, referring to FIG. 13, the SRS resource set may be configured according to [Method 2].

A first case 1300 illustrates an example in which a base station configures the RRC parameter applyIndicatedTCI-State to have the same value (e.g., “first”) in all SRS resource sets 1301, 1305, and 1307 for antenna switching with respect to all time-domain behaviors in the UE. Depending on the RRC parameter configured by the base station, the UE may transmit an SRS resource 1302 for periodic antenna switching or SRS resources 1306 and 1308 for aperiodic antenna switching according to the first TCI state. Although different TCI states may be applied according to a time point at which each SRS resource 1302 for periodic antenna switching or SRS resources 1306 and 1308 for aperiodic antenna switching is transmitted, the UE may transmit an SRS resources within an SRS resource set configured by applying the first TCI state among the plurality of TCI states.

A second case 1310 illustrates an example in which the base station configures the RRC parameter applyIndicatedTCI-State to have the same value (e.g., “first”) in all SRS resource sets 1315 and 1317 for antenna switching with respect to some time-domain behaviors (e.g., aperiodic) in the UE. The UE may transmit, depending on the RRC parameter configured by the base station, SRS resources 1316 and 1318 for aperiodic antenna switching according to the first TCI state and the SRS resources 1312 for periodic antenna switching according to the second TCI state.

[Method 1] and [Method 2] described above may be used to support sDCI-based mTRP or mDCI-based mTRP.

### [Method 3]

[Method 3] assumes a case in which a base station and a UE support sDCI-based mTRP technique and the base station does not configure an RRC parameter (e.g., applyIndicatedTCI-State) in the UE to indicate a TCI state for all SRS resource sets, which are for antenna switching and are configured for a predetermined same time-domain behavior.

The base station may make a configuration such that the srs-TCI-State of the SRS resource having at least the lowest SRS-ResourceId in all SRS resource sets, which are for antenna switching and are configured for a predetermined same time-domain behavior have the same value in the UE. As a specific example, for multiple SRS resource sets which are for antenna switching and for a time-domain behavior configured as aperiodic, the base station may configure the srs-TCI-State, which is configured in the first SRS resource having at least the lowest SRS-ResourceId in each SRS resource set, to have the same value in the UE. Alternatively, for multiple SRS resource sets which are for antenna switching and for a time-domain behavior configured as aperiodic, the base station may make a configuration such that the srs-TCI-State, which is configured in some or all SRS resources within each SRS resource set, has the same value in the UE.

If the base station does not configure the RRC parameter to indicate a TCI state for all SRS resource sets and supports the sDCI-based mTRP technique, the UE may expect that the srs-TCI-State of the SRS resource having at least the lowest SRS-ResourceId in all SRS resource sets, which are for antenna switching and are configured for a predetermined same time-domain behavior, is configured to have the same value. As a specific example, if the base station does not configure the RRC parameter to indicate a TCI state for all SRS resource sets and supports the sDCI-based mTRP technique, the UE may expect that the srs-TCI-State of the SRS resource having at least the lowest SRS-ResourceId in all SRS resource sets which are for antenna switching and configured for a time-domain behavior as aperiodic is configured to have the same value.

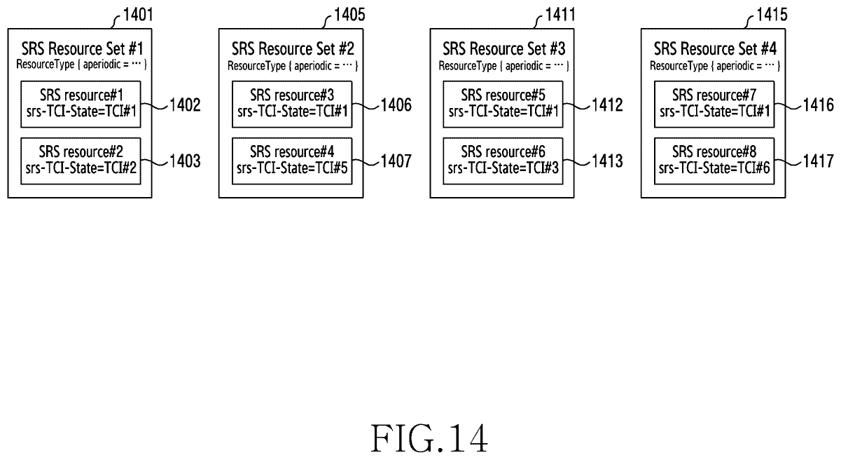

FIG. 14 illustrates an example of an SRS resource set configured according to an embodiment of the present disclosure. Specifically, referring to FIG. 14, the SRS resource set may be configured according to [Method 3].

According to FIG. 14, the base station may configure a plurality (e.g., four) of SRS resource sets 1401, 1405, 1411, and 1415 with a time-domain behavior configured as aperiodic in the UE. If the base station does not configure an RRC parameter (e.g., applyIndicatedTCI-State) to indicate a TCI state to all SRS resource sets, the base station may configure the srs-TCI-State in the SRS resource having the lowest SRS-ResourceId (it may be assumed that x in SRS resource #x in FIG. 14 denotes SRS-ResourceId) within each of SRS resource sets 1401, 1405, 1411, and 1415 to have the same value (e.g., TCI-UL-StateId or TCI-StateId to indicate TCI #1).

### [Method 4]

[Method 4] assumes a case in which a base station and a UE support mDCI-based mTRP technique and the base station does not configure, for the UE, an RRC parameter (e.g., applyIndicatedTCI-State) to indicate a TCI state for all SRS resource sets, which are for antenna switching and are configured for the same time-domain behavior. The base station may configure higher layer parameters in the UE to ensure that all SRS resource sets, which are for antenna switching and are configured for the same time-domain behavior, are scheduled at the same time point. The base station may configure higher layer parameters in the UE to allow all SRS resource sets which are for antenna switching and are configured for a time-domain behavior of aperiodic to be triggered and scheduled by single DCI. The base station may configure the same aperiodicSRS-ResourceTrigger value for all SRS resource sets in the UE so that all SRS resource sets for antenna switching of aperiodic may be triggered by single DCI. If the base station schedules the UE with an SRS request area in single DCI with the same value as the aperiodicSRS-ResourceTrigger value configured for all SRS resource sets for antenna switching of aperiodic, the UE may transmit all SRS resources in all SRS resource sets using a joint TCI state or UL TCI state indicated by the coresetPoolIndex value associated with the CORESET in which a PDCCH that has triggered all SRS resource sets for antenna switching of aperiodic is received.

If the base station does not configure the RRC parameter to indicate a TCI state for all SRS resource sets and supports mDCI-based mTRP technique, the UE may expect to receive higher layer parameters configured so that all SRS resource sets, which are for antenna switching and are configured for a predetermined same time-domain behavior, are scheduled at the same time point. The UE may expect that the aperiodicSRS-ResourceTrigger values configured for all SRS resource sets which are for antenna switching with a time-domain behavior of aperiodic are the same.

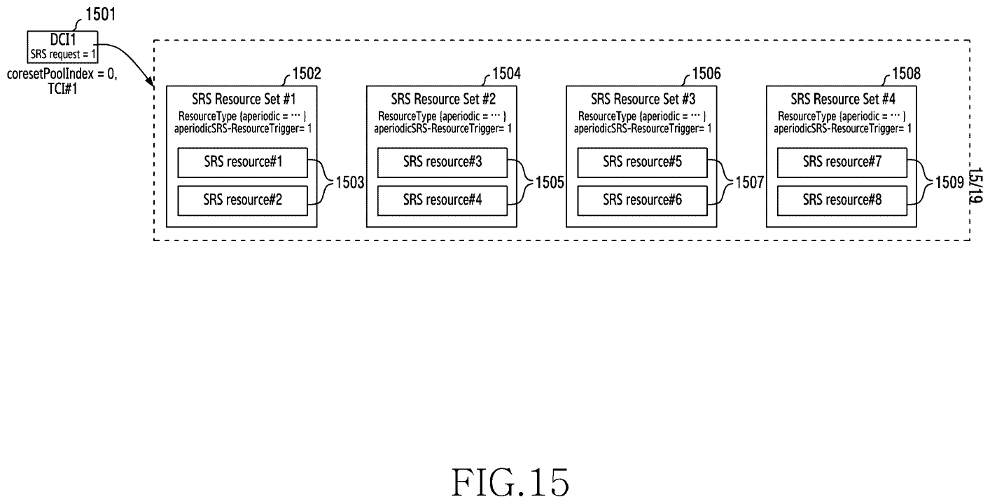

FIG. 15 illustrates an example of an SRS resource set when the SRS resource set is triggered according to an embodiment of the present disclosure. Specifically, referring to FIG. 15, the SRS resource set may be configured according to [Method 4].

The base station may configure the same aperiodicSRS-ResourceTrigger value for all SRS resource sets 1502, 1504, 1506, and 1508 for antenna switching with respect to a time-domain behavior of aperiodic in the UE. The example of FIG. 15 assumes the case in which the aperiodicSRS-ResourceTrigger of all aperiodic SRS resource sets 1502, 1504, 1506, and 1508 is configured to have a value of “1.” The base station may transmit DCI1 1501 to the UE to trigger an aperiodic SRS. An SRS request area in the DCI1 1501 may indicate a trigger state value for triggering the aperiodic SRS, and the example in FIG. 15 shows a case in which the base station configures the SRS request area to have a value of “1” and indicates the same to the UE. The UE may receive the DCI1 1501 and transmit aperiodic SRS resource sets 1502, 1504, 1506, and 1508 with aperiodicSRS-ResourceTrigger configured as “1” according to a value of “1” configured in the SRS resource area indicated by DCI1. Here, since DCI1 is indicated to the UE via a PDCCH received through a CORESET with a coresetPoolIndex value of “0,” the UE may transmit the aperiodic SRS resource set 1502, 1504, 1506, and 1508 triggered by applying the first TCI state (TCI #1 in FIG. 15) determined by coresetPoolIndex 0.

### [Method 5]

[Method 5] assumes a case in which a base station and a UE support mDCI-based mTRP technique and the base station does not configure, for the UE, an RRC parameter (e.g., applyIndicatedTCI-State) to indicate a TCI state for all SRS resource sets, which are for antenna switching and are configured for a predetermined same time-domain behavior. The base station may configure, for the UE, a predetermined same candidate value for the higher layer parameters so that all SRS resource sets, which are for antenna switching and are configured for a predetermined same time-domain behavior, are scheduled at the same time point. The base station may configure a predetermined same candidate value for the higher layer parameter in the UE so that all SRS resource sets, which are for antenna switching and are configured for a time-domain behavior of aperiodic, may be triggered and scheduled by single DCI. The base station may configure the aperiodicSRS-ResourceTriggerList in all SRS resource sets to have the same at least one trigger state value in the UE so that all SRS resource sets for antenna switching of aperiodic may be triggered by single DCI. If the base station schedules the UE with an SRS request area in single DCI with a predetermined value in the aperiodicSRS-ResourceTriggerList included in all SRS resource sets of aperiodic antenna switching usage, the UE may transmit all SRS resources in all SRS resource sets using the joint TCI state or UL TCI state indicated by a coresetPoolIndex value associated with a CORESET in which a PDCCH that has triggered all SRS resource sets for the aperiodic antenna switching.

If the base station does not configure an RRC parameter to indicate a TCI state for all SRS resource sets and supports the mDCI-based mTRP technique, the UE may expect a predetermined same candidate value to be configured for the higher layer parameter so that all SRS resource sets, which are for antenna switching and are configured for a predetermined same time-domain behavior, are scheduled at the same time point. The UE may expect that the aperiodicSRS-ResourceTriggerList configured for all SRS resource sets, which are for antenna switching and are configured for a time-domain behavior of aperiodic, is configured to have the same at least one trigger state.

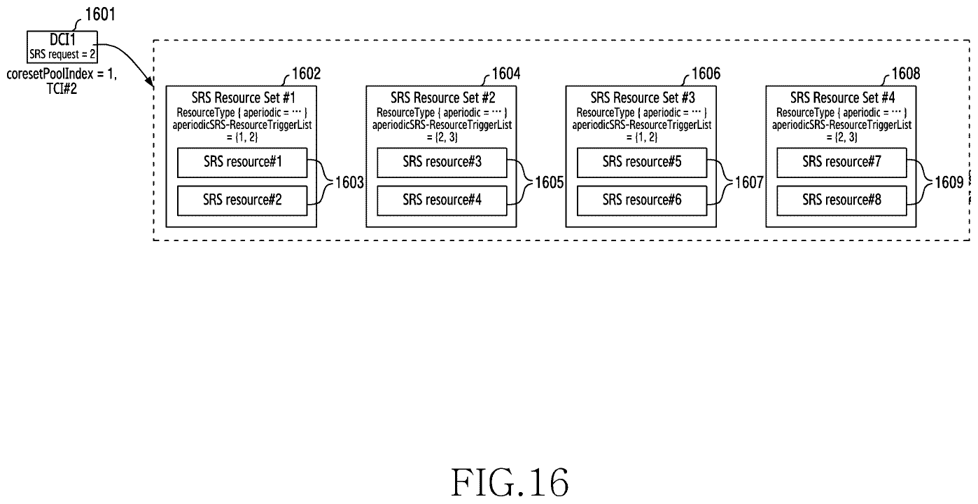

FIG. 16 illustrates an example of an SRS resource set when the SRS resource set is triggered according to an embodiment of the present disclosure. Specifically, referring to FIG. 16, the SRS resource set may be configured according to method 5.

The base station may configure, for the UE, an aperiodicSRS-ResourceTriggerList including the same value for all SRS resource sets 1602, 1604, 1606, and 1608 for antenna switching with respect to a time-domain behavior of aperiodic. The example in FIG. 16 assumes a case in which the aperiodicSRS-ResourceTriggerList of all aperiodic SRS resource sets 1602, 1604, 1606, and 1608 is configured to have a common value of “2.” The base station may transmit DCI1 1601 to the UE to trigger the aperiodic SRS. The SRS request area in DCI1 1601 may indicate a trigger state value for triggering the aperiodic SRS, and the example in FIG. 16 shows a case in which the base station configures the SRS request area to have a value of “2” and indicates the same to the UE. The UE may receive DCI1 1601 and transmit aperiodic SRS resource sets 1602, 1604, 1606, and 1608 having the aperiodicSRS-ResourceTriggerList including a value of “2” according to a value of “2” configured in the SRS resource area indicated by DCI1. Here, since DCI1 is indicated to the UE by a PDCCH received via a CORESET with a coresetPoolIndex value of “1,” the UE may transmit the aperiodic SRS resource sets 1602, 1604, 1606, and 1608 triggered by applying a second TCI state (TCI #2 in FIG. 16) determined by coresetPoolIndex 1.

### [Method 6]

[Method 6] assumes a case in which a base station and a UE support the mDCI-based mTRP technique and the base station does not configure, for the UE, an RRC parameter (e.g., apply IndicatedTCI-State) to indicate a TCI state for all SRS resource sets which are antenna switching and are configured for the same time-domain behavior. The base station may schedule SRS resource set transmissions to the UE so that all SRS resource sets, which are for antenna switching and are configured for the same time-domain behavior, are associated with the same coresetPoolIndex value and transmitted. The base station may perform scheduling for the UE so that all SRS resource sets for antenna switching with respect to a time-domain behavior of aperiodic are triggered by PDCCHs received in the CORESET associated with the same coresetPoolIndex value. If the base station triggers all SRS resource sets for antenna switching applications with a time-domain behavior of aperiodic by PDCCHs received in the CORESET associated with the same coresetPoolIndex value, the UE may transmit all SRS resources in all SRS resource sets using the joint TCI state or UL TCI state indicated by the coresetPoolIndex value associated with the CORESET in which the PDCCH that triggered all SRS resource sets for the corresponding aperiodic antenna switching usage is received.

If the base station does not configure an RRC parameter to indicate a TCI state for all SRS resource sets and supports the mDCI-based mTRP technique, the UE may expect to receive SRS resource set transmissions scheduled so that all SRS resource sets, which are for antenna switching and are configured for a predetermined same time-domain behavior, are transmitted in association with the same coresetPoolIndex value. The UE may expect that all SRS resource sets for antenna switching with respect to a time-domain behavior of aperiodic are scheduled (or triggered) by PDCCHs received in the CORESET associated with the same coresetPoolIndex value.

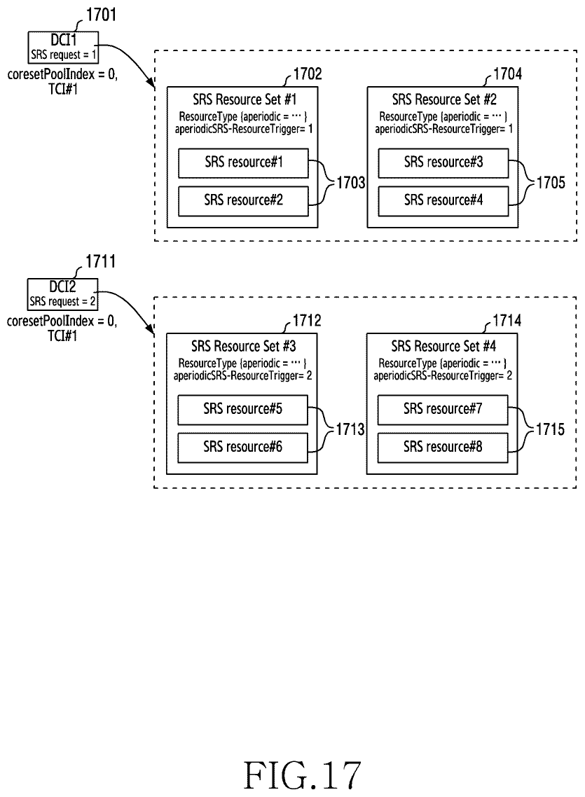

FIG. 17 illustrates an example of an SRS resource set when the SRS resource set is triggered according to an embodiment of the present disclosure. Specifically, referring to FIG. 17, the SRS resource set may be configured according to [Method 6].

The base station may, by considering triggering flexibility, configure the aperiodicSRS-ResourceTrigger of some SRS resource sets 1702 and 1704 of the SRS resource sets for antenna switching with respect to a time-domain behavior of aperiodic to have a value of “1” and configure the aperiodicSRS-ResourceTrigger of the remaining SRS resource sets 1712 and 1714 to have a value of “2.” The base station may trigger all SRS resource sets 1702, 1704, 1712, and 1714 for antenna switching of aperiodic by multiple pieces of DCI1 1701 and DCI2 1711. Since both DCI1 and DCI2 are indicated to the UE by PDCCHs received via a CORESET with a coresetPoolIndex value of “0,” the UE may transmit the aperiodic SRS resource sets 1702, 1704, 1712, and 1714 triggered by applying the first TCI state (TCI #1 in FIG. 17) determined by coresetPoolIndex 0.

### [Method 7]

If the base station does not configure an RRC parameter (e.g., applyIndicatedTCI-State) to indicate a TCI state for all SRS resource sets which are for antenna switching and are configured for a predetermined same time-domain behavior, the UE may transmit all the scheduled SRS resource sets, which are for antenna switching and are configured for a predetermined same time-domain behavior, by applying only one TCI state thereto. For example, if the base station does not configure the RRC parameter to indicate the TCI state for all SRS resource sets for switching with a time-domain behavior configured as aperiodic, the UE may transmit all the scheduled SRS resource sets for antenna switching of aperiodic by applying the first TCI state (or the second TCI state) of the two indicated TCI states thereto.

In [Method 1] to [Method 7] described above, the time-domain behavior of the SRS resource set is determined by the “resourceType” in the higher layer parameter SRS-ResourceSet of the SRS resource set, and the base station configures the “resourceType” with respect to a predetermined SRS resource set as one of the values of aperiodic, semi-persistent, or periodic.

Additionally, the base station and UE may support the sDCI-based mTRP technique as follows. Specifically, the base station may configure an RRC parameter (e.g., applyIndicatedTCI-State) in the UE to indicate the TCI state for some SRS resource sets which are for antenna switching and are configured for a predetermined same time-domain behavior, but may not configure an RRC parameter to indicate the TCI state for the remaining SRS resource sets. In this case, the base station and the UE may perform the operation according to [Method 8].

### [Method 8]

The base station may make a configuration in the UE such that all SRS resource sets for antenna switching and configured for a predetermined same time-domain behavior can be transmitted with the same transmission power parameter. To this end, the base station may configure an RRC parameter in the UE so that the TCI state (or TCI-UL-State) indicated by apply IndicatedTCI-State for an SRS resource set with applyIndicatedTCI-State configured and the srs-TCI-State of an SRS resource having the lowest SRS-ResourceId for an SRS resource set with no applyIndicatedTCI-State configured have the same value, and may activate the TCI state via MAC CE and instruct the same via DCI.

The UE may calculate (or determine) the same transmission power for all SRS resource sets for antenna switching and configured for a predetermined same time-domain behavior according to [Method 1] to [Method 8] described above. The UE may calculate (or determine) the transmission power of the SRS to be transmitted as shown in the following equation 2, by using the RRC parameter configured in the SRS resource set and the transmission power parameter indicated by the TCI-State (or TCI-UL-State) applied for SRS transmission.

$$[ Equation 2 ]$$

$${P}_{SRS , b , f , c} ( i , {q}_{s} , l ) = min \{ \begin{matrix}\text{?} ( i ) , \\ \begin{matrix}\text{?} ( {q}_{s} ) + 10 {log}_{10} ( {2}^{μ} * {M}_{SRS , b , f , c} ( i ) ) + \\ \text{?} ( {q}_{s} ) \cdot {PL}_{b , f , c} ( {q}_{d} ) + {h}_{b , f , c} ( i , l )\end{matrix}\end{matrix} \} [ dBm ]$$

$$\text{?} \text{indicates text missing or illegible when filed}$$

P_{CMAX,f,c}(i): This is the maximum transmission power available by the UE in the i-th transmission unit, and may be determined by the power class of the UE and parameters activated by the base station and various parameters embedded in the UE.
P_{0,SRS,b,f,c}(qₛ): Higher layer signaling p0 may be configured for a bandwidth part b, a carrier frequency f, and a cell c, and the SRS resource set qs may be configured through the higher layer signaling SRS-ResourceSet and SRS-ResourceSetId.
μ: This may denote a value of the subcarrier spacing configuration.
M_{SRS,b,f,c}(i): This may denote the amount of resources used in the i-th SRS transmission unit (e.g., the number of resource blocks (RBs) used for SRS transmission on the frequency axis).
α_{SRS,b,f,c}(j): Higher layer signaling alpha may be configured for a bandwidth part b, a carrier frequency f, and a cell c, and the SRS resource set qs may be configured via the higher layer signaling SRS-ResourceSet and SRS-ResourceSetId.
PL_{b,f,c}(q_{d}): This may indicate a path loss between a base station and a UE, the UE may calculate (or determine) a pathloss from the difference between the transmission power of the reference signal (RS) resource qd signaled by the base station and the UE's received signal level of the reference signal.
h_{b,f,c}(i, l): This may denote an SRS power control adjustment state value for the i-th SRS transmission unit corresponding to closed loop index l within a bandwidth part b, a carrier frequency f, and a cell c.

If the base station supports the enhanced unified TCI framework to support sTRP and mTRP by configuring TCI-State or indicating TCI-UL-State in the dl-OrJointTci-StateList in the UE, P₀_{_{SRS}}_{,b,f,c}(qₛ) in Equation 2 described above may be defined as the sum of p0 configured in the SRS resource set and

$${P}_{{0}_{{UE}_{SRS}} , b , f , c} ( {q}_{s} )$$

identified by p0AlphaSetforSRS, which is indicated by TCI-State (or TCI-UL-State). Therefore, if one or more SRS resource sets configured as a predetermined resourceType (e.g., “aperiodic”) are transmitted and the base station configures TCI-State or TCI-UL-State in the dl-OrJointTci-StateList for the UE, the UE may expect that the same p0 value configured in one or more SRS resource sets, and may expect that one or more SRS resource sets are associated with the p0AlphaSetforSRS and pathlossReferenceRs-Id having the same value. In other words, the UE may expect that the RRC parameter is configured to match the transmission power of the SRS resources of antenna switching usage transmitted through the multiple SRS resource sets as described above, and may expect that the multiple SRS resource sets, which are for antenna switching and are configured for a predetermined same time-domain behavior, have the same p0 value configured and the TCI-State or TCI-UL-State indicating the same value of p0AlphaSetforSRS is indicated or configured as the RRC parameter. Alternatively, if the same p0 value is not configured in one or more SRS resource sets, the UE may expect that the sum of p0 configured in each SRS resource and

$${P}_{{0}_{{UE}_{SRS}} , b , f , c} ( {q}_{s} )$$

indicated by the p0AlphaSetforSRS associated with each SRS resource set is configured and indicated to have the same value.

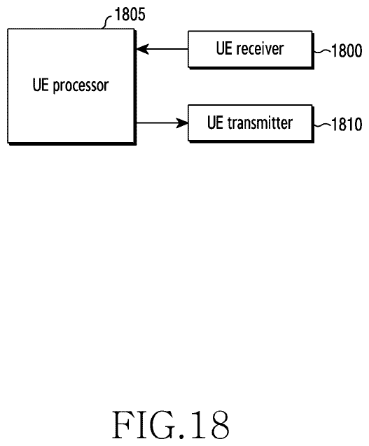

FIG. 18 illustrates an example of a structure of a UE in a wireless communication system according to an embodiment of the present disclosure.

Referring to FIG. 18, the UE may include a transceiver, which refers to a UE receiver 1800 and a UE transmitter 1810 as a whole, a memory (not illustrated), and a UE processor 1805 (or UE controller or processor). The UE transceiver 1800 and 1810, the memory, and the UE processor 1805 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

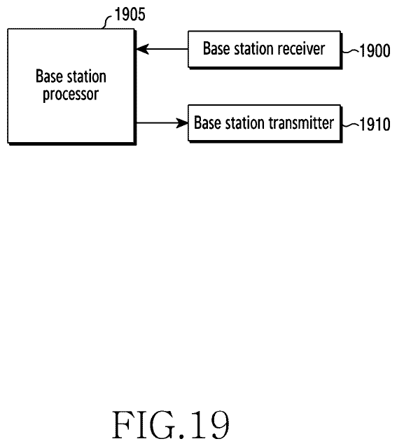

FIG. 19 illustrates an example of a structure of a base station in a wireless communication system according to an embodiment of the present disclosure.

Referring to FIG. 19, the base station may include a transceiver, which refers to a base station receiver 1900 and a base station transmitter 1910 as a whole, a memory (not illustrated), and a base station processor 1905 (or base station controller or processor). The base station receiver 1900 and 1910, the memory, and the base station processor on may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, configuration information related to a usage and a type of one or more sounding reference signal (SRS) resource sets;
receiving, from the base station, information on a transmission configuration indication (TCI) state for the one or more SRS resource sets; and
determining, based on the configuration information and the TCI state, a transmission power of the one or more SRS resource sets.

2. The method of claim 1, wherein determining the transmission power comprises determining, based on the TCI state for the one or more SRS resource sets, a transmission power parameter for each of the one or more SRS resource sets as a same value in case that the usage of the one or more SRS resource sets is set to antenna switching and the type of the one or more SRS resource sets is set to aperiodic.

3. The method of claim 1, wherein the TCI state for at least one SRS resource included in each of the one or more SRS resource sets is set to a same value in case that the usage of the one or more SRS resource sets is set to antenna switching and the type of the one or more SRS resource sets is set to aperiodic.

4. The method of claim 1, wherein the configuration information comprises an SRS-TCI-state parameter for each of at least one SRS resource included in each of the one or more SRS resource sets, and
wherein determining the transmission power comprises determining the transmission power based on the SRS-TCI-state parameter of the SRS resource having a lowest SRS resource identifier of the at least one SRS resource included in each of the one or more SRS resource sets.

5. The method of claim 1, wherein the information on the TCI state includes TCI-State in dl-OrJointTCI-StateList or TCI-UL-State.

6. A method performed by a base station in a wireless communication system, the method comprising:
transmitting, to a terminal, configuration information related to a usage and a type of one or more sounding reference signal (SRS) resource sets; and
transmitting, to the terminal, information on a transmission configuration indication (TCI) state for the one or more SRS resource sets;
wherein a transmission power of the one or more SRS resource sets is determined based on the configuration information and the TCI state.

7. The method of claim 6, wherein a transmission power parameter for each of the one or more SRS resource sets is determined as a same value based on the TCI state for the one or more SRS resource sets in case that the usage of the one or more SRS resource sets is set to antenna switching and the type of the one or more SRS resource sets is set to aperiodic.

8. The method of claim 6, wherein the TCI state for at least one SRS resource included in each of the one or more SRS resource sets is set to a same value in case that the usage of the one or more SRS resource sets is set to antenna switching and the type of the one or more SRS resource sets is set to aperiodic.

9. The method of claim 6, wherein the configuration information comprises an SRS-TCI-state parameter for each of at least one SRS resource included in each of the one or more SRS resource sets, and
wherein the transmission power is determined based on the SRS-TCI-state parameter of the SRS resource having a lowest SRS resource identifier of the at least one SRS resource included in each of the one or more SRS resource sets.

10. The method of claim 6, wherein the information on the TCI state includes TCI-State in dl-OrJointTCI-StateList or TCI-UL-State.

11. A terminal in a wireless communication system, the terminal comprising:
a transceiver; and
a controller coupled with the transceiver and configured to:
receive, from a base station, configuration information related to a usage and a type of one or more sounding reference signal (SRS) resource sets,
receive, from the base station, information on a transmission configuration indication (TCI) state for the one or more SRS resource sets, and
determine, based on the configuration information and the TCI state, a transmission power of the one or more SRS resource sets.

12. The terminal of claim 11, wherein the controller is further configured to determine, based on the TCI state for the one or more SRS resource sets, a transmission power parameter for each of the one or more SRS resource sets as a same value in case that the usage of the one or more SRS resource sets is set to antenna switching and the type of the one or more SRS resource sets is set to aperiodic.

13. The terminal of claim 11, wherein the TCI state for at least one SRS resource included in each of the one or more SRS resource sets is set a same value in case that the usage of the one or more SRS resource sets is set to antenna switching and the type of the one or more SRS resource sets is set to aperiodic.

14. The terminal of claim 11, wherein the configuration information comprises an SRS-TCI-state parameter for each of at least one SRS resource included in each of the one or more SRS resource sets, and
wherein the controller is further configured to determine the transmission power based on the SRS-TCI-state parameter of the SRS resource having a lowest SRS resource identifier of the at least one SRS resource included in each of the one or more SRS resource sets.

15. The terminal of claim 11, wherein the information on the TCI state includes TCI-State in dl-OrJointTCI-StateList or TCI-UL-State.

16. A base station in a wireless communication system, the base station comprising:
a transceiver; and
a controller coupled with the transceiver and configured to:
transmit, to a terminal, configuration information related to a usage and a type of one or more sounding reference signal (SRS) resource sets, and
transmit, to the terminal, information on a transmission configuration indication (TCI) state for the one or more SRS resource sets, and
wherein a transmission power of the one or more SRS resource sets is determined based on the configuration information and the TCI state.

17. The base station of claim 16, wherein a transmission power parameter for each of the one or more SRS resource sets is determined as a same value based on the TCI state for the one or more SRS resource sets in case that the usage of the one or more SRS resource sets is set to antenna switching and the type of the one or more SRS resource sets is set to aperiodic.

18. The base station of claim 16, wherein the TCI state for at least one SRS resource included in each of the one or more SRS resource sets is set to a same value in case that the usage of the one or more SRS resource sets is set to antenna switching and the type of the one or more SRS resource sets is set to aperiodic.

19. The base station of claim 16, wherein the configuration information comprises an SRS-TCI-state parameter for each of at least one SRS resource included in each of the one or more SRS resource sets, and
wherein the transmission power is determined based on the SRS-TCI-state parameter of the SRS resource having a lowest SRS resource identifier of the at least one SRS resource included in each of the one or more SRS resource sets.

20. The base station of claim 16, wherein the information on the TCI state includes TCI-State in dl-OrJointTCI-StateList or TCI-UL-State.
